(19) United States
(12) Patent Application Publication
(10) Pub. No.: US 2002/0025137 A1
(43) Pub. Date: Feb. 28, 2002

(54) Audeo reproducing apparatus, audeo reproducing method, video-audio reproducing apparatus, and video-audio reproducing method

(76) Inventor: Mitsuyoshi Suzuki, Tokyo (JP)

Correspondence Address: BURNS DOANE SWECKER & MATHIS L L P, POST OFFICE BOX 1404, ALEXANDRIA, VA, 22313-1404, US

(21) Appl. No.: 09/761,852

(22) Filed: Jan. 18, 2001

(30) Foreign Application Priority Data
Aug. 24, 2000 (JP) 2000-254459

(51) Int. Cl. H04N 5/91; H04N 7/04; H04N 7/06; H04N 7/08; H04N 7/52

(52) U.S. Cl. 386/75; 386/96

(57) ABSTRACT

An audio reproducing apparatus comprises an audio buffer memory unit for temporarily storing decoded audio data and a source audio position in correspondence with each other; a reproducing speed control unit for generating a minute frame periodic pulse and a reproducing position signal that specifies a reproducing position calculated from a reproducing position function; and a counter for receiving the reproducing position signal and the minute frame periodic pulse and outputting reproduced audio data obtained by reproducing the decoded audio data in the audio buffer memory unit in a normal manner from a source audio position corresponding to the reproducing position by an amount corresponding to a period T of the minute frame periodic pulse. Due to this configuration, special reproduction of audio signals results in an efficient audible sound.

### BACKGROUND OF THE INVENTION

1. Field of the Invention

The present invention relates to an audio reproducing apparatus and an audio reproducing method for performing special reproductions of decoded audio data according to reproducing speed, and also relates to a video-audio reproducing apparatus and a video-audio reproducing method for performing special reproduction of an image while ensuring its matching with sound.

2. Description of the Related Art

FIG. 14 is a schematic diagram of a conventional audio reproducing apparatus.

In FIG. 14, reference numeral 101 denotes a reproducing command; reference numeral 102 denotes a reproducing speed control unit; reference numeral 103 is a reading position signal; reference numeral 104 is a storage media unit; reference numeral 105 denotes a source audio data; reference numeral 106 is an audio decoder; and reference numeral 107 denotes a decoded audio data.

Next, the operation of the conventional audio reproducing apparatus will be described.

When the reproducing speed control unit 102 externally receives a reproducing command 101 for special reproduction that specifies a reproducing speed such as fast forward or slow motion, the reproducing speed control unit 102 outputs a reading position signal 103 to the storage media unit 104. The source audio data 105 in the storage media unit 104 represents PCM sound, international standard MPEG sound or the like, which is obtained by sampling sound as it is. The storage media unit 104 outputs source audio data 105, which is read from a reading position specified by the reading position signal 103, to the audio decoder 106.

The number of samples of decoded audio data 107 per unit frame is increased or decreased in proportion to reproducing speed, and therefore it results in varied frequency. For example, the frequency in double-speed reproduction is twice as high as that of normal reproduction, and the frequency in half-speed reproduction is one-half as high as that of normal reproduction.

In addition, Japanese Patent Application Laid-Open No. Hei 11-136638 discloses techniques with regard to a video-audio reproducing apparatus and a video-audio reproducing method for special reproductions of moving images including reverse-direction reproduction.

Since the conventional audio reproducing apparatus and audio reproducing method are comprised as described above, special reproduction involving changes in reproducing speed results in varied frequency, and therefore the conventional audio reproducing apparatus and audio reproducing method have a problem in that it is difficult to hear resulting special reproduced sound.

In addition, since the conventional video-audio reproducing apparatus and video-audio reproducing method are comprised as described above, it has not been possible to perform special reproduction of sound in conjunction with special reproduction of a moving image. For example, output sound in special reproduction is muted, and therefore it presents a problem in that realism in special reproduction of moving images is lost.

The present invention has been made to solve problems as described above. An object of the present invention is to form an audio reproducing apparatus and an audio reproducing method that make it possible to freely change reproducing speed without making it difficult to hear special reproduced sound.

Another object of the present invention is to form a video-audio reproducing apparatus and a video-audio reproducing method that make it possible to perform special reproduction of sound in conjunction with special reproduction of a moving image.

### SUMMARY OF THE INVENTION

In order to achieve the above object, an audio reproducing apparatus according to a first aspect of the present invention is constructed in such a manner that decoded audio data is divided by a minute frame, and a reproducing position for each minute frame is determined by a reproducing position function obtained by time integration of a reproducing speed, so that the decoded audio data is reproduced in a normal manner from source audio positions each corresponding to a reproducing position by an amount corresponding to the minute frame.

An audio reproducing apparatus according to a second aspect of the present invention comprises an audio buffer memory unit for temporarily storing decoded audio data and a source audio position in correspondence with each other; a reproducing speed control unit for outputting reproducing positions calculated individually for each minute frame by a reproducing position function that is obtained by time integration of a reproducing speed; and a counter for reproducing the decoded audio data in the audio buffer memory unit in a normal manner from source audio positions respectively corresponding to the reproducing positions by an amount corresponding to a minute frame.

An audio reproducing apparatus according to another aspect of the present invention includes an audio filter for filtering the decoded audio data reproduced by the counter in a normal manner.

An audio reproducing apparatus according to another aspect of the present invention is constructed such that the audio buffer memory unit is brought into a through state, whereby the decoded audio data is outputted.

An audio reproducing apparatus according to another aspect of the present invention is constructed such that the audio buffer memory unit and the audio filter are each brought into a through state, whereby the decoded audio data is outputted.

An audio reproducing apparatus according to another aspect of the present invention is constructed such that when reverse-direction reproduction is performed, the counter reproduces decoded audio data in the audio buffer memory unit in a reverse direction at a single-speed from source audio positions each corresponding to a reproducing position by an amount corresponding to a minute frame.

An audio reproducing apparatus according to another aspect of the present invention is constructed such that the reproducing speed control unit corrects a reproducing position for output in such a manner that a central source audio position of decoded audio data to be reproduced by an amount corresponding to a minute frame in a normal manner or in a reverse direction at a single-speed is read at a central time of each minute frame.

An audio reproducing apparatus according to another aspect of the present invention is constructed such that it includes a consonant detector for detecting a consonant portion and a source audio position of the consonant portion from decoded audio data, whereby referring to the consonant detector, the reproducing speed control unit corrects a reproducing position for output in such a manner that the source audio position of the consonant portion is included in source audio positions of decoded audio data to be reproduced by an amount corresponding to a minute frame in a normal manner or in a reverse direction at a single-speed.

An audio reproducing method for performing special reproductions of decoded audio data according to reproducing speed according to one aspect of the present invention is constructed such that the decoded audio data is divided by a minute frame, and a reproducing position for each of said minute frames is determined by a reproducing position function obtained by time integration of the reproducing speed, so that the decoded audio data is reproduced in a normal manner from source audio positions respectively corresponding to the reproducing positions by an amount corresponding to the minute frame, wherein the method comprising: an audio data buffering step for temporarily storing the decoded audio data and a source audio position in correspondence with each other; a reproducing speed control step for outputting reproducing positions calculated individually for each minute frame by a reproducing position function that is obtained by time integration of the reproducing speed; and an audio data reading step for reproducing the decoded audio data in the audio data buffering step in a normal manner from the source audio positions respectively corresponding to the reproducing positions by an amount corresponding to the minute frame.

An audio reproducing method according to another aspect of the present invention is constructed such that it includes an audio data filtering step for filtering the decoded audio data reproduced in a normal manner in the audio data reading step.

An audio reproducing method according to another aspect of the present invention is constructed such that the audio data buffering step is brought into a through state, whereby the decoded audio data is outputted.

An audio reproducing method according to another aspect of the present invention is constructed such that the audio data buffering step and the audio data filtering step are each brought into a through state, whereby the decoded audio data is outputted.

An audio reproducing method according to another aspect of the present invention is constructed such that when reverse-direction reproduction is performed, decoded audio data in the audio data buffering step is reproduced in the audio data reading step in a reverse direction at a single-speed from source audio positions each corresponding to a reproducing position by an amount corresponding to a minute frame.

An audio reproducing method according to another aspect of the present invention is constructed such that a reproducing position is corrected for output in the reproducing speed control step in such a manner that a central source audio position of decoded audio data to be reproduced by an amount corresponding to a minute frame in a normal manner or in a reverse direction at a single-speed is read at a central time of each minute frame.

An audio reproducing method according to another aspect of the present invention is constructed such that it includes a consonant detecting step for detecting a consonant portion and a source audio position of the consonant portion from decoded audio data, whereby referring to the consonant detecting step, a reproducing position is corrected for output in the reproducing speed control step in such a manner that the source audio position of the consonant portion is included in source audio positions of decoded audio data to be reproduced by an amount corresponding to a minute frame in a normal manner or in a reverse direction at a single-speed.

A video-audio reproducing apparatus for performing special reproductions of decoded audio data and decoded video data according to reproducing speed according to one aspect of the present invention is constructed such that it comprises: an audio buffer memory unit for temporarily storing the decoded audio data and a source audio position in correspondence with each other; a reproducing speed control unit for outputting reproducing positions calculated individually for each minute frame by a reproducing position function that is obtained by time integration of the reproducing speed; and a counter for reproducing the decoded audio data in the audio buffer memory unit in a normal manner from the source audio positions respectively corresponding to the reproducing positions by an amount corresponding to the minute frame, and wherein the reproducing speed control unit further outputs a reproducing address for each minute frame for an image, which reproducing addresses each corresponding to a reproducing position calculated by the reproducing position function, and wherein the video-audio reproducing apparatus further comprises; a video buffer memory unit for temporarily storing decoded video data and a source video position in correspondence with each other, and a video address generator for outputting the decoded video data in the video buffer memory unit from source video positions each corresponding to a reproducing address by an amount corresponding to a minute frame for an image.

A video-audio reproducing apparatus according to another aspect of the present invention is constructed such that it includes a video filter for filtering the decoded video data outputted by the video address generator.

A video-audio reproducing apparatus according to another aspect of the present invention is constructed such that the video buffer memory unit is brought into a through state, whereby the decoded video data is outputted.

A video-audio reproducing apparatus according to another aspect of the present invention is constructed such that the video buffer memory unit and the video filter are each brought into a through state, whereby the decoded video data is outputted.

A video-audio reproducing method for performing special reproductions of decoded audio data and decoded video data according to reproducing speed according to one aspect of the present invention is constructed such that it comprises: an audio data buffering step for temporarily storing the decoded audio data and a source audio position in correspondence with each other; a reproducing speed control step for outputting reproducing positions calculated individually for each minute frame by a reproducing position function that is obtained by time integration of the reproducing speed; and an audio data reading step for reproducing the decoded audio data in the audio data buffering step in a normal manner from the source audio positions respectively corresponding to the reproducing positions by an amount corresponding to the minute frame, wherein in the reproducing speed control step, a reproducing address for each minute frame for an image is outputted, which reproducing addresses each corresponding to a reproducing position calculated by the reproducing position function, and wherein the video-audio reproducing method further comprises; a video data buffering step for temporarily storing decoded video data and a source video position in correspondence with each other; and a video address generating step for outputting the decoded video data in a video buffer memory unit from source video positions each corresponding to a reproducing address by an amount corresponding to a minute frame for an image.

A video-audio reproducing method according to another aspect of the present invention is constructed such that it includes a video filtering step for filtering the decoded video data outputted in the video address generating step.

A video-audio reproducing method according to another aspect of the present invention is constructed such that the video data buffering step is brought into a through state, whereby the decoded video data is outputted.

A video-audio reproducing method according to another aspect of the present invention is constructed such that the video data buffering step and the video filtering step are each brought into a through state, whereby the decoded video data is outputted.

### BRIEF DESCRIPTION OF THE DRAWINGS

FIG. 1 is a schematic diagram of an audio reproducing apparatus according to a first embodiment of the present invention.

FIG. 2 is a diagram of assistance in explaining an audio reproducing method according to the first embodiment of the present invention.

FIG. 3 shows relations between source audio f₁(p), a reproducing position function p₁(t) for normal reproduction, and a reproducing position function p₂(t) for forward-direction double-speed reproduction.

FIG. 4 shows special reproduced sound f₂(p) resulting from forward-direction double-speed reproduction.

FIG. 5 shows an example of reproduced sound resulting from special reproduction.

FIG. 6 is a schematic diagram of an audio reproducing apparatus according to a second embodiment of the present invention.

FIG. 7 is a diagram of assistance in explaining an audio reproducing method according to the second embodiment of the present invention.

FIG. 8 is a diagram of assistance in explaining an audio reproducing method according to a third embodiment of the present invention.

FIG. 9 is a diagram of assistance in explaining an audio reproducing method according to the third embodiment of the present invention.

FIG. 10 is a schematic diagram of an audio reproducing apparatus according to a fourth embodiment of the present invention.

FIG. 11 is a diagram of assistance in explaining an audio reproducing method according to the fourth embodiment of the present invention.

FIG. 12 is a schematic diagram of a video-audio reproducing apparatus according to a fifth embodiment of the present invention.

FIG. 13 is a diagram of assistance in explaining a video-audio reproducing method according to the fifth embodiment of the present invention.

FIG. 14 is a schematic diagram of a conventional audio reproducing apparatus.

### DETAILED DESCRIPTION OF THE PREFERRED EMBODIMENTS

An embodiment of the present invention will now be described.

(First Embodiment)

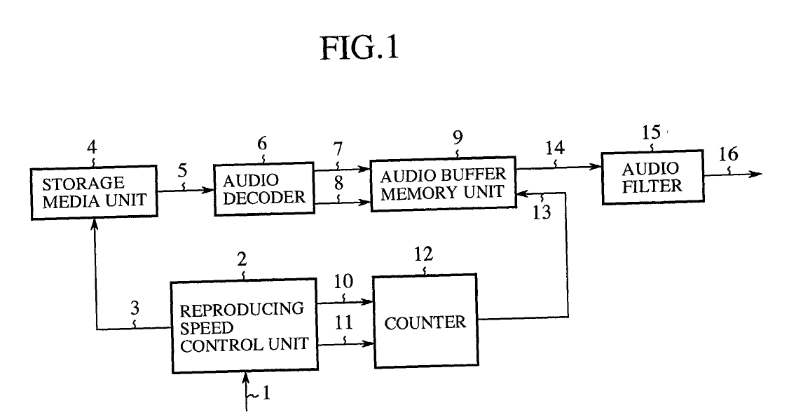

FIG. 1 is a schematic diagram of an audio reproducing apparatus according to a first embodiment of the present invention.

In FIG. 1, reference numeral 1 denotes a reproducing command that specifies a speed at which source audio data is reproduced. Reference numeral 2 denotes a reproducing speed control unit that controls a reproducing speed according to the reproducing command 1. Reference numeral 3 denotes a reading position signal that specifies a position at which source audio data is read. Reference numeral 4 denotes a storage media unit that stores source audio data. Reference numeral 5 denotes source audio data read from the storage media unit 4 according to the reading position signal 3. Reference numeral 6 denotes an audio decoder that decodes the source audio data 5. Reference numeral 7 denotes audio data decoded by the audio decoder 6.

Reference numeral 8 denotes a source audio position outputted in correspondence with the decoded audio data 7. Reference numeral 9 denotes an audio buffer memory unit that temporarily stores the decoded audio data 7 and the source audio position 8. Reference numeral 10 denotes a reproducing position signal that specifies a reproducing position that is calculated by a reproducing position function. Here, the source audio position 8 means the reproducing time that has elapsed in the case where all the source audio data 5 stored in the storage media unit 4 is reproduced from the beginning in a normal manner. The reproducing position function is a function obtained by the time integration of a reproducing speed, and is used to determine a reproducing position that corresponds to a source audio position 8 of decoded audio data 7 to be reproduced and outputted at a time t.

Reference numeral 11 denotes a minute frame periodic pulse having a period T for generating minute frames. Reference numeral 12 denotes a counter that receives the reproducing position signal 10 and also counts the minute frame periodic pulse 11. Reference numeral 13 denotes a source audio position specifying signal that specifies a source audio position 8 to be reproduced by determining the position from the reproducing position signal 10 and a count value of the minute frame periodic pulse 11. Reference numeral 14 denotes a reproduced audio data that is reproduced from the audio buffer memory unit 9. Reference numeral 15 denotes an audio filter that filters the reproduced audio data 14. Reference numeral 16 denotes a reproduced sound outputted by the audio reproducing apparatus of this first embodiment.

Next, the operation of the audio reproducing apparatus according to a first embodiment of the present invention will be described.

Normal reproduction (forward-direction single-speed reproduction) is performed as follows. A source audio data 5 is decoded by the audio decoder 6, and the audio buffer memory unit 9 and the audio filter 15 are brought into a through state (a passage state) (through state of an audio data buffering step and that of an audio filtering step), whereby a reproduced sound 16 in normal reproduction is obtained.

When the reproducing speed control unit 2 externally receives a reproducing command 1 for special reproduction that specifies a reproducing speed such as fast forward or slow motion (a positive value in the case of forward-direction reproduction and a negative value in the case of reverse-direction reproduction), the reproducing command including a reproducing direction, which is either a forward direction or a reverse direction, the reproducing speed control unit 2 outputs a reading position signal 3 to the storage media unit 4. The source audio data 5 in the storage media unit 4 represents a PCM sound, an international standard MPEG sound or the like, which is obtained by sampling a sound as it is. The storage media unit 4 outputs a source audio data 5, which is read from a reading position specified by the reading position signal 3, and sends it to the audio decoder 6.

The audio decoder 6 outputs a decoded audio data 7 obtained by decoding the source audio data 5, and sends it to the audio buffer memory unit 9, and also writes a source audio position 8 corresponding to the decoded audio data 7 into the audio buffer memory unit 9 (audio data buffering step).

Processing for special reproduction is performed after a certain amount of the decoded audio data 7 is stored in the audio buffer memory unit 9. Specifically, the reading of the decoded audio data 7 from the audio buffer memory unit 9 will be performed after an amount of the decoded audio data 7 that is necessary and sufficient for special reproduction processing is written into the audio buffer memory unit 9.

The reproducing speed control unit 2 outputs a minute frame periodic pulse 11 having a period T to the counter 12, and at the same time, the reproducing speed control unit 2 outputs a reproducing position signal 10 to the counter 12 (reproducing speed control step). The minute frame periodic pulse 11 having a period T outputted by the reproducing speed control unit 2 has a function of dividing the decoded audio data 7 by a minute frame having a width T.

After receiving the reproducing position signal 10, the counter 12 specifies a source audio position 8 corresponding to a reproducing position of the reproducing position signal 10, and supplies the source audio position 8 to the audio buffer memory unit 9-by means of a source audio position specifying signal 13. The decoded audio data 7 in the audio buffer memory unit 9 is read from the source audio position 8 as a reproduced audio data 14 at a reproducing speed of normal reproduction by an amount corresponding to the period T of the minute frame periodic pulse 11 (audio data reading step). Thus, the reproduced audio data 14 contained in each minute frame retains a source audio frequency.

The reproduced audio data 14 includes a high-frequency noise caused by a discontinuity occurring at a boundary between minute frames. In order to remove this high-frequency noise, the reproduced audio data 14 is filtered by the audio filter 15, and thereby reproduced sound 16 is obtained (audio data filtering step). Incidentally, the width of a minute frame is a few milliseconds to several hundred milliseconds.

In the operation described above, the reading by the counter 12 of the decoded audio data 7 stored in the audio buffer memory unit 9 will be described in further detail.

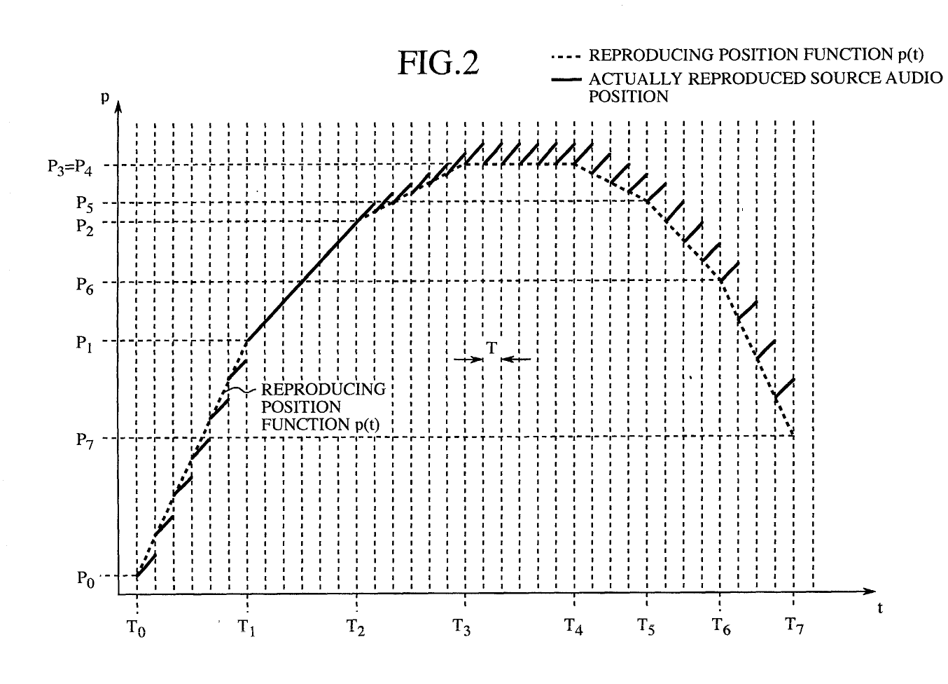

FIG. 2 is a diagram of assistance in explaining an audio reproducing method according to the first embodiment of the present invention.

In FIG. 2, the axis of abscissas denotes time t, while the axis of ordinates denotes reproducing position p. In addition, a broken line denotes a reproducing position function p(t), while a solid line denotes source audio positions where actual reproduction is performed. Processing for special reproductions in this case is started at a time T₀ and at a reproducing position P₀.

The time t in FIG. 2 is divided into a plurality of reproducing frames that have different reproducing speeds. Specifically, when a frame from time T_{X} to time T_{Y} is represented by a sign [T_{X}˜T_{Y}], [T₀˜T₁] represents a forward-direction double-speed reproducing frame; [T₁˜T₂] represents a normal reproducing frame; [T₂˜T₃] represents a forward-direction half-speed reproducing frame; [T₃˜T₄] represents a pause frame; [T₄˜T₅) represents a reverse-direction half-speed reproducing frame; [T₅˜T₆] represents a reverse-direction single-speed reproducing frame; and [T₆˜T₇] represents a reverse-direction double-speed reproducing frame.

The following are relations between a reproducing position function p(t), times t, and reproducing positions p in each reproducing frame and the period T of the minute frame periodic pulse 11.

Forward-direction double-speed reproducing frame [T₀˜T₁]

p(t)=P₀+2(t−T₀)T₁=T₀+6T, P₁=p(T₁)=P₀+12T (1)

Normal reproducing frame [T₁˜T₂]

p(t)=P₁+(t−T₁)T₂=T₁+6T, P₂=p(T₂)=P₁+6T (2)

Forward-direction half-speed reproducing frame [T₂˜T₃]

p(t)=P₂+0.5(t−T₂)T₃=T₂+6T, P₃=p(T₃)=P₂+3T (3)

Pause frame [T₃˜T₄]

p(t)=P₃T₄=T₃+6T, P₄=p(T₄)=P₃ (4)

Reverse-direction half-speed reproducing frame [T₄˜T₃]

p(t)=P₄−0.5(t−T₄)T₅=T₄+4T, P₅=p(T₅)=P₄−2T (5)

Reverse-direction single-speed reproducing frame [T₅˜T₆]

(t)=P₅−(t−T₅)T₆=T₅+4T, P₆=p(T₆)=P₅−4T (6)

Reverse-direction double-speed reproducing frame [T₆˜T₇]

p(t)=P₆−2(t−T₆)T₇=T₆+4T, P₇=p(T₇)=P₆−8T (7)

Processing for special reproductions in each reproducing frame will hereinafter be described from a microscopic point of view of each minute frame. Incidentally, a sign <P_{X}˜P_{Y}> represents source audio positions in a range from P_{X} to P_{Y}.

Forward-direction double-speed reproducing frame [T₀˜T₁]

In a first minute frame [T₀˜T₀+T], a reproducing position P₀ at a time T₀ is determined by the reproducing position function (1). Then, decoded audio data 7 is reproduced in a normal manner from a source audio position 8 corresponding to the reproducing position P₀ by an amount corresponding to time T (period of the minute frame periodic pulse 11). Thus, <P₀˜P₀+T> is subjected to the reproduction processing.

In the next minute frame [T₀T˜T₀+2T], a reproducing position P₀+2T at a time T₀+T is determined by the reproducing position function (1). Then, decoded audio data 7 is reproduced in a normal manner from a source audio position 8 corresponding to the reproducing position P₀+2T by an amount corresponding to time T. Thus, <P₀+T˜P₀+2T> is excluded from the reproduction processing, while <P₀+2T˜P₀+3T> is subjected to the reproduction processing.

Furthermore, in the next minute frame [T₀+2T˜T₀+3T], a reproducing position P₀+4T at a time T₀+2T is determined by the reproducing position function (1). Then, decoded audio data 7 is reproduced in a normal manner from a source audio position 8 corresponding to the reproducing position P₀+4T by an amount corresponding to time T. Thus, <P₀+3T˜P₀+4T> is excluded from the reproduction processing, while <P₀+4T˜P₀+5T> is subjected to the reproduction processing.

Such reproduction processing is repeated for each minute frame. When <P₀+10T˜P₀+11T> has been subjected to the reproduction processing in the last minute frame [T₀+5T˜T₀+6T], a forward-direction double-speed reproducing frame [T₀˜T₁] is completed.

Normal reproducing frame [T₁˜T₂]

According to the reproducing position function (2), <P₁˜P₁+T> in [T₁˜T₁+T], <P₁+T˜P₁+2T> in [T₁+T˜T₁+2T], . . . , <P₁+5T˜P₁+6T> in [T₁+5T˜T₁+6T] are all reproduced in a normal manner. Since the frame [T₁˜T₂] is a normal reproducing frame, the operation performed here is processing for the normal reproduction.

Forward-direction half-speed reproducing frame [T₂˜T₃]

In a first minute frame [T₂˜T₂+T], a reproducing position P₂ at a time T₂ is determined by the reproducing position function (3). Then, decoded audio data 7 is reproduced in a normal manner from a source audio position 8 corresponding to the reproducing position P₂ by an amount corresponding to time T. Thus, <P₂˜P₂ +T> is subjected to the reproduction processing.

In the next minute frame [T₂+T˜T₂+2T], a reproducing position P₂+0.5T at a time T₂+T is determined by the reproducing position function (3). Then, decoded audio data 7 is reproduced in a normal manner from a source audio position 8 corresponding to the reproducing position P₂+0.5T by an amount corresponding to time T. Thus, <P₂+0.5T˜P₂+T> is subjected to repeated reproduction processing, while <P₂+0.5T˜P₂+1.5T> is subjected to the reproduction processing.

Furthermore, in the next minute frame [T₂+2T˜T₂+3T], a reproducing position P₂+T at a time T₂+2T is determined by the reproducing position function (3). Then, decoded audio data 7 is reproduced in a normal manner from a source audio position 8 corresponding to the reproducing position P₂+T by an amount corresponding to time T. Thus, <P₂+T P₂+1.5T> is subjected to the repeated reproduction processing, while <P₂+T˜P₂+2T> is subjected to reproduction processing.

Such reproduction processing is repeated for each minute frame. When <P₂+2.5T˜P₂+3.5T> has been subjected to reproduction processing in the last minute frame [T₂+5T˜T₂+6T], a forward-direction half-speed reproducing frame [T₂˜T₃] is completed.

Pause frame [T₃˜T₄]

According to the reproducing position function (4), <P₃˜P₃+T> in [T₃˜T₃+T], <P₃˜P₃+T> in [T₃+T˜T₃+2T], . . . , <P₃˜P₃+T> in [T₃+5T˜T₃+6T] are all reproduced in a normal manner. The frame [T₃˜T₄] is a pause frame, and therefore in the operation performed here, <P₃˜P₃+T> is repeatedly subjected to reproduction processing.

Reverse-direction half-speed reproducing frame [T₄˜T₅]

In a first minute frame [T₄˜T₄+T], a reproducing position P₄ at a time T₄ is determined by the reproducing position function (5). Then, decoded audio data 7 is reproduced in a normal manner from a source audio position 8 corresponding to the reproducing position P₄ by an amount corresponding to time T. Thus, <P₄˜P₄+T> is subjected to reproduction processing.

In the next minute frame [T₄+T˜T₄+2T], a reproducing position P₄−0.5T at a time T₄+T is determined by the reproducing position function (5). Then, decoded audio data 7 is reproduced in a normal manner from a source audio position 8 corresponding to the reproducing position P₄−0.5T by an amount corresponding to time T. Thus, <P₄˜P₄+0.5T> is subjected to repeated reproduction processing, while <P₄−0.5T˜P₄+0.5T> is subjected to the reproduction processing.

Furthermore, in the next minute frame [T₄+2T˜T₄+3T], a reproducing position P₄−T at a time T₄+2T is determined by the reproducing position function (5). Then, decoded audio data 7 is reproduced in a normal manner from a source audio position 8 corresponding to the reproducing position P₄−T by an amount corresponding to time T. Thus, <P₄−0.5T˜P₄> is subjected to repeated reproduction processing, while <P₄−T˜P₄> is subjected to the reproduction processing.

Such reproduction processing is repeated for each minute frame. When <P₄−2.5T˜P₄−1.5T> has been subjected to reproduction processing in the last minute frame [T₄+5T˜T₄+6T], a reverse-direction half-speed reproducing frame (T₄˜T₅] is completed.

Reverse-direction single-speed reproducing frame [T₅˜T₆]

In a first minute frame [T₅˜T₅+T], a reproducing position P₅ at a time T₅ is determined by the reproducing position function (6). Then, decoded audio data 7 is reproduced in a normal manner from a source audio position 8 corresponding to the reproducing position P₅ by an amount corresponding to time T. Thus, <P₅˜P₅+T> is subjected to reproduction processing.

In the next minute frame [T₅+T˜T₅+2T], a reproducing position P₅−T at a time T₅+T is determined by the reproducing position function (6). Then, decoded audio data 7 is reproduced in a normal manner from a source audio position 8 corresponding to the reproducing position P₅−T by an amount corresponding to time T. Thus, <P₅−T˜P₅> is subjected to reproduction processing.

Furthermore, in the next minute frame [T₅+2T˜T₅+3T], a reproducing position P₅−2T at a time T₅+2T is determined by the reproducing position function (6). Then, decoded audio data 7 is reproduced in a normal manner from a source audio position 8 corresponding to the reproducing position P₅−2T by an amount corresponding to time T. Thus, <P₅−2T˜P₅−T> is subjected to reproduction processing.

Such reproduction processing is repeated for each minute frame. When <P₅−3T˜P₅−2T> has been subjected to reproduction processing in the last minute frame [T₅+3T˜T₅+4T], a reverse-direction single-speed reproducing frame [T₅˜T₆] is completed.

Reverse-direction double-speed reproducing frame [T₆˜T₇].

In a first minute frame [T₆˜T₆+T], a reproducing position P₆ at a time T₆ is determined by the reproducing position function (7). Then, decoded audio data 7 is reproduced in a normal manner from a source audio position 8 corresponding to the reproducing position P₆ by an amount corresponding to time T. Thus, <P₆˜P₆+T> is subjected to reproduction processing.

In the next minute frame [T₆+T˜T₆+2T], a reproducing position P₆−2T at a time T₆+T is determined by the reproducing position function (7). Then, decoded audio data 7 is reproduced in a normal manner from a source audio position 8 corresponding to the reproducing position P₆−2T by an amount corresponding to time T. Thus, <P₆−T˜P₆> is excluded from reproduction processing, while <P₆−2T˜P₆−T> is subjected to reproduction processing.

Furthermore, in the next minute frame [T₆+2T˜T₆+3T], a reproducing position P₆−4T at a time T₆+2T is determined by the reproducing position function (7). Then, decoded audio data 7 is reproduced in a normal manner from a source audio position 8 corresponding to the reproducing position P₆−4T by an amount corresponding to time T. Thus, <P₆−3T˜P₆−2T> is excluded from reproduction processing, while <P₆−4T˜P₆−3T> is subjected to reproduction processing.

Such reproduction processing is repeated for each minute frame. When <P₆−6T˜P₆−5T> has been subjected to reproduction processing in the last minute frame [T₆+3T˜T₆+4T], a reverse-direction double-speed reproducing frame [T₆˜T₇] is completed.

As described above, in the audio reproducing apparatus according to the first embodiment, the reproducing speed control unit 2 calculates a reproducing position by using a reproducing position function obtained by time integration of a reproducing speed. Also, decoded audio data 7 in the audio buffer memory unit 9 is read by the counter 12 in a normal reproducing manner from a source audio position 8 corresponding to the reproducing position by an amount corresponding to the period T of the minute frame periodic pulse 11. Thus, depending on the reproducing speed, a minute frame is excluded from reproduction processing or is subjected to repeated reproduction processing. In addition, in a minute frame where reproduction processing is performed, a source audio frequency is retained. Therefore, unlike a conventional audio reproducing apparatus, the audio reproducing apparatus according to the first embodiment is capable of performing special audio reproduction without producing sound that is difficult to hear.

In an arbitrary reproducing frame [Tₓ˜T_{y}], a reproducing position function for a K speed (K is an arbitrary number including a positive or negative sign; K>0 represents forward-direction reproduction, K=0 represents pause reproduction, and K<0 represents reverse-direction reproduction) is generally expressed as an equation (8). In the equation (8), Pₓ is a reproducing position corresponding to a time Tₓ.

p(t)=Pₓ+K(t−Tₓ) (8)

In order to understand the operation described above, a simple example of special reproduced sound outputted by the apparatus for special reproduction according to the first embodiment will hereinafter be illustrated by taking a forward-direction double-speed reproducing frame as an example.

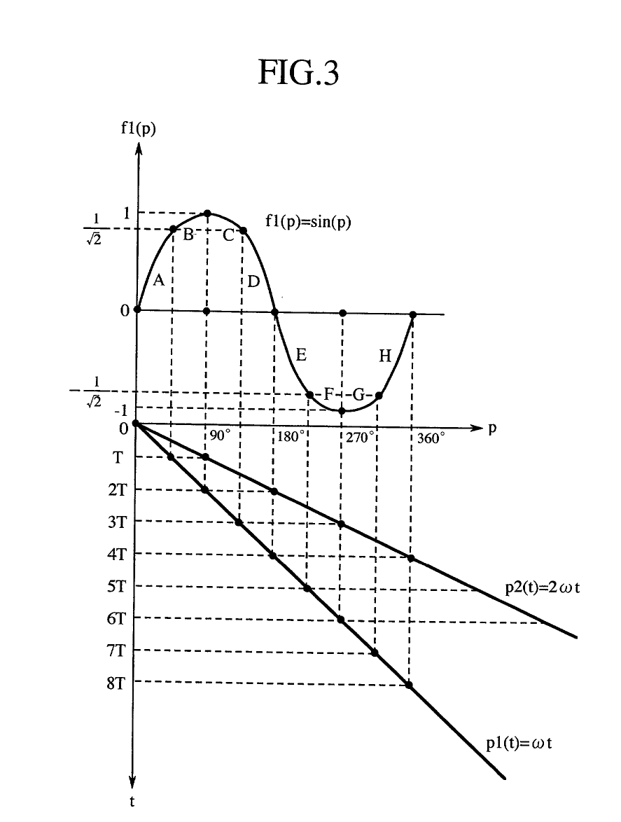

FIG. 3 shows relations between source audio f₁(p), a reproducing position function p₁(t) for normal reproduction, and a reproducing position function p₂(t) for forward-direction double-speed reproduction. In actuality, f₁(p), p₁(t), and p₂(t) assume discrete values; in this example, however, they are represented by using continuous values for the sake of simplicity. In FIG. 3, the axis of abscissas denotes reproducing position p, which is represented by using phase in this example. The lower side and the upper side of the axis of ordinates, the sides being separated by the axis of abscissas, denote time t and source audio f₁(p), respectively.

In a region where time t is set to be an independent variable and reproducing position p is set to be a dependent variable, a reproducing position function p=p₁(t)=ωt for normal reproduction and a reproducing position function p=p₂(t)=2ωt for forward-direction double-speed reproduction are shown. The reproducing position function p₁(t) for normal reproduction represents source audio positions 8. The symbol ω represents a speed at which normal reproduction is performed, and corresponds to the angular frequency of a source signal. As described above, it is understood that reproducing position functions p₁(t) and p₂(t) are obtained by time integration of a reproducing speed ω. The initial value of reproducing position (constant of integration) is p₀=0.

In a region where reproducing position p is set to be an independent variable and source audio f₁(p) is set to be a dependent variable, source audio f₁(p)=sin (p₁)=sin (ωt) is shown (in FIG. 3, one period of the source audio is shown). In the figure, a time frame [0˜8T] that corresponds to source audio positions <0°˜360°> is divided by a minute frame into eight equal parts. Source audio positions <0°˜45°>, . . . , <315°˜360°> and divided waveforms A, . . . , H correspond to minute frames [0˜T], . . . , [7T˜8T], respectively. In this case, ω=(2π)/(8T)=π/(4T), and the minute frame represents tens of milliseconds, while the frequency of the source audio represents tens of hertz.

In this example, forward-direction double-speed reproduction is performed. Therefore, a reproducing position function p=p₂(t)=2ωt is used to determine reproducing positions p₂(t) that correspond to times t=0, T, 2T, 3T, . . . , respectively. As a result, p₂(0)=0°, p₂(T)=90°, p₂(2T)=180°, p₂(3T)=270°, . . . are obtained.

Thus, source audio positions corresponding to the above reproducing positions p₂(t) are <0°˜45°>, <90°˜135°>, <180°˜225°>, <270°˜315°>, . . . , respectively. When decoded audio data 7 is reproduced in a normal manner on the basis of these source audio positions, special reproduced sound resulting from forward-direction double-speed reproduction is obtained.

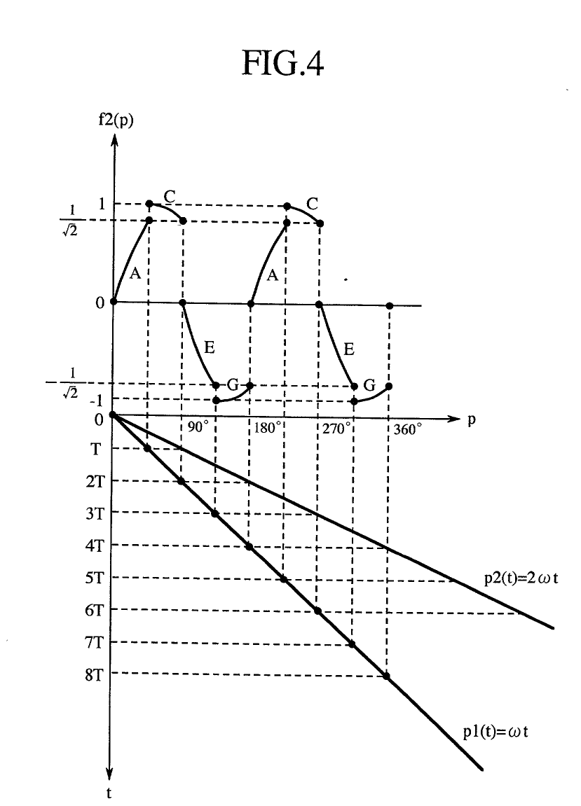

FIG. 4 shows the special reproduced sound f₂(p) resulting from forward-direction double-speed reproduction. As is clear from FIG. 4, each minute frame retains the frequency of the source audio f₁(p), and divided waveforms A, C, E, and G are subjected to reproduction processing, while divided waveforms B, D, F, and H are excluded from reproduction processing. At times t=0, T, 2T, 3T, discontinuity of the special reproduced sound f₂(p) occurs. In order to eliminate high-frequency noise caused by the discontinuity, the reproduced sound f₂(p) of FIG. 4 is inputted to the audio filter 15.

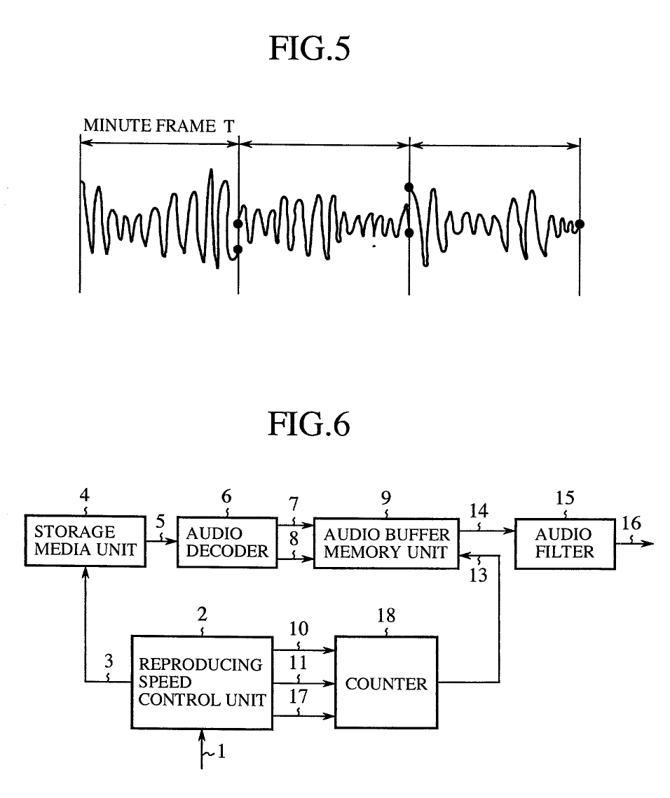

Even when the frequency of source audio becomes higher, its reproduction can be considered in the same manner as in the cases of FIGS. 3 and 4. The reproduced sound resulting from special reproduction is outputted in a manner as shown in FIG. 5, for example. It is to be noted that the reproduction described above is not limited to forward-direction double-speed reproduction, and therefore reproductions at other special speeds can be considered in the same manner as described above.

As described above, according to the first embodiment, there are provided an audio buffer memory unit 9 for temporarily storing decoded audio data 7 obtained by decoding source audio data 5 and a source audio position 8 representing reproducing time that has elapsed when all the source audio data 5 is reproduced from the beginning in a normal manner, the decoded audio data 7 and the source audio position 8 being made to correspond to each other; a reproducing speed control unit 2 for generating a minute frame periodic pulse 11 and a reproducing position signal 10 that specifies a reproducing position calculated from a reproducing position function that is obtained by time integration of a reproducing speed; and a counter 12 for receiving the reproducing position signal 10 and the minute frame periodic pulse 11 and outputting reproduced audio data 14 obtained by reproducing the decoded audio data 7 in the audio buffer memory unit 9 in a normal manner from a source audio position 8 corresponding to the reproducing position by an amount corresponding to a period T of the minute frame periodic pulse 11. Therefore, a minute frame that has been subjected to reproduction processing retains a source audio frequency. Also, depending on the reproducing speed, each minute frame is excluded from reproduction processing or is subjected to repeated reproduction processing. Thus, it is possible to perform special reproduction without producing sound that is difficult to hear.

In addition, according to the first embodiment, an audio filter 15 for filtering the reproduced audio data 14 is provided. Therefore, it is possible to eliminate high-frequency noise caused by discontinuity of the reproduced audio data 14, and thereby output special reproduced sound of higher quality.

Furthermore, according to the first embodiment, the audio buffer memory unit 9 and the audio filter 15 are each brought into a through state and the decoded audio data 7 is read, so that reproduced sound 16 in normal reproduction can be outputted.

(Second Embodiment)

According to the first embodiment, in both the cases of forward-direction reproduction and reverse-direction reproduction, decoded audio data is reproduced in a normal manner (forward-direction single-speed reproduction) in each minute frame. However, in reproducing frames where reverse-direction reproduction is specified, decoded audio data 7 may be reproduced in a reverse direction at a single-speed in each minute frame.

FIG. 6 is a schematic diagram of an audio reproducing apparatus according to a second embodiment of the present invention. Components identical with or corresponding to those in FIG. 1 are identified by the same reference numerals.

In FIG. 6, reference numeral 17 denotes a reverse-direction specifying signal, which is outputted by a reproducing speed control unit 2 when the reproducing speed of a reproducing command 1 is negative. Reference numeral 18 denotes a counter, which is different from the counter 12 in the first embodiment in that the counter 18 has a function of reading decoded audio data 7 in an audio buffer memory unit 9 in a reverse direction at a single-speed when a reverse-direction specifying signal 17 is inputted.

Next, the operation of the audio reproducing apparatus according to a second embodiment of the present invention will be described.

When the reproducing speed of a reproducing command 1 is zero or more, that is, when pause reproduction or forward-direction reproduction is to be performed, the same operation as in the first embodiment is performed.

On the other hand, when the reproducing speed of a reproducing command 1 is negative, that is, when reverse-direction reproduction is to be performed, the reproducing speed control unit 2 inputs a reverse-direction specifying signal 17 into the counter 18. The counter 18, to which the reverse-direction specifying signal 17 is inputted, reads decoded audio data 7 in a reverse direction at a single-speed from a source audio position 8 corresponding to a reproducing position of each minute frame by an amount corresponding to time T (audio data reading step).

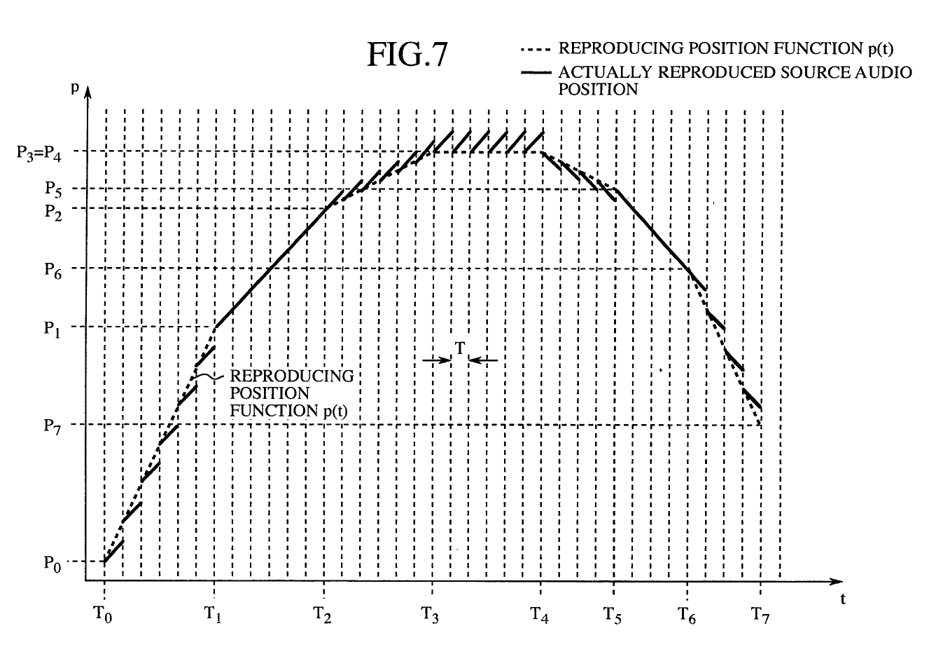

FIG. 7 is a diagram of assistance in explaining an audio reproducing method according to the second embodiment of the present invention.

A reproducing position function in each reproducing frame in FIG. 7 is the same as that of FIG. 2. Therefore, audio reproducing methods in [T₀˜T₁], [T₁˜T₂], [T₂˜T₃], and [T₃˜T₄] are the same as those of the first embodiment. Each of the reverse-direction reproducing frames [T₄˜T₅], [T₅˜T₆], and [T₆˜T₇], in which audio reproducing methods are different from those of the first embodiment, will hereinafter be described.

Reverse-direction half-speed reproducing frame [T₄˜T₅]

In a first minute frame [T₄˜T₄+T], a reproducing position P₄ at a time T₄ is determined by the reproducing position function (5). Then, decoded audio data 7 is reproduced in a reverse direction at a single-speed from a source audio position 8 corresponding to the reproducing position P₄ by an amount corresponding to time T. Thus, <P₄˜P₄−T> is subjected to reproduction processing.

In the next minute frame [T₄+T˜T₄+2T], a reproducing position P₄−0.5T at a time T₄+T is determined by the reproducing position function (5). Then, decoded audio data 7 is reproduced in a reverse direction at a single-speed from a source audio position 8 corresponding to the reproducing position P₄−0.5T by an amount corresponding to time T. Thus, <P₄−0.5T˜P₄−T> is subjected to repeated reproduction processing, while <P₄−0.5T˜P₄−1.5T> is subjected to reproduction processing.

Furthermore, in the next minute frame [T₄+2T˜T₄+3T], a reproducing position P₄−T at a time T₄+2T is determined by the reproducing position function (5). Then, decoded audio data 7 is reproduced in a reverse direction at a single-speed from a source audio position 8 corresponding to the reproducing position P₄−T by an amount corresponding to time T. Thus, <P₄−T˜P₄−1.5T> is subjected to repeated reproduction processing, while <P₄−T˜P₄−2T> is subjected to reproduction processing.

Such reproduction processing is repeated for each minute frame. When <P₄−1.5T˜P₄−2.5T> has been subjected to reproduction processing in the last minute frame [T₄+3T˜T₄+4T], a reverse-direction half-speed reproducing frame [T₄˜T₅] is completed.

Reverse-direction single-speed reproducing frame [T₅˜T₆]

In a first minute frame [T₅˜T₅+T], a reproducing position P₅ at a time T, is determined by the reproducing position function (6). Then, decoded audio data 7 is reproduced in a reverse direction at a single-speed from a source audio position 8 corresponding to the reproducing position P₅ by an amount corresponding to time T. Thus, <P₅˜P₅−T> is subjected to reproduction processing.

In the next minute frame [T₅+T˜T₅+2T], a reproducing position P₅−T at a time T₅+T is determined by the reproducing position function (6). Then, decoded audio data 7 is reproduced in a reverse direction at a single-speed from a source audio position 8 corresponding to the reproducing position P₅˜T by an amount corresponding to time T. Thus, <P₅−T˜P₅−2T> is subjected to reproduction processing.

Furthermore, in the next minute frame [T₅+2T˜T₅+3T], a reproducing position P₅−2T at a time T₅+2T is determined by the reproducing position function (6). Then, decoded audio data 7 is reproduced in a reverse direction at a single-speed from a source audio position 8 corresponding to the reproducing position P₅−2T by an amount corresponding to time T. Thus, <P₅−2T˜P₅−3T> is subjected to reproduction processing.

Such reproduction processing is repeated for each minute frame. When <P₅−3T˜P₅−4T> has been subjected to reproduction processing in the last minute frame [T₅+3T˜T₅+4T], a reverse-direction single-speed reproducing frame [T₅˜T₆] is completed.

Reverse-direction double-speed reproducing frame [T₆˜T₇].

In a first minute frame [T₆˜T₆+T], a reproducing position P₆ at a time T₆ is determined by the reproducing position function (7). Then, decoded audio data 7 is reproduced in a reverse direction at a single-speed from a source audio position 8 corresponding to the reproducing position P₆ by an amount corresponding to time T. Thus, <P₆˜P₆−T> is subjected to reverse-direction single-speed reproduction processing.

In the next minute frame [T₆+T˜T₆+2T], a reproducing position P₆−2T at a time T₆+T is determined by the reproducing position function (7). Then, decoded audio data 7 is reproduced in a reverse direction at a single-speed from a source audio position 8 corresponding to the reproducing position P₆−2T by an amount corresponding to time T. Thus, <P₆−T˜P₆−2T> is excluded from reproduction processing, while <P₆−2T˜P₆−3T> is subjected to reproduction processing.

Furthermore, in the next minute frame [T₆+2T˜T₆+3T], a reproducing position P₆−4T at a time T₆+2T is determined by the reproducing position function (7). Then, decoded audio data 7 is reproduced in a reverse direction at a single-speed from a source audio position 8 corresponding to the reproducing position P₆−4T by an amount corresponding to time T. Thus, <P₆−3T˜P₆−4T> is excluded from reproduction processing, while <P₆−4T˜P₆−5T> is subjected to reproduction processing.

Such reproduction processing is repeated for each minute frame. When <P₆−6T˜P₆−7T> has been subjected to reproduction processing in the last minute frame [T₆+3T˜T₆+4T], a reverse-direction double-speed reproducing frame [T₆˜T₇] is completed.

A comparison of FIG. 7 with FIG. 2 indicates that the discontinuity of actually reproduced source audio positions 8 is reduced in FIG. 7. This makes it possible to suppress effects of high-frequency noise caused by the discontinuity.

As described above, according to the second embodiment, when a reproducing command 1 specifies a negative reproducing speed, the reproducing speed control unit 2 outputs a reverse-direction specifying signal 17 to the counter 18. Then, the counter 18, to which the reverse-direction specifying signal 17 is inputted, reads decoded audio data 7 in a reverse direction at a single-speed from a source audio position 8 corresponding to a reproducing position in each minute frame by an amount corresponding to time T. Therefore, as compared with the first embodiment, the second embodiment makes it possible to reduce discontinuity occurring at boundaries between minute frames for reverse-direction reproduction. Thus, it is possible to output special reproduced sound of high quality while suppressing high-frequency noise. Also, when reverse-direction reproduction is performed, decoded audio data 7 is read in a reverse direction, and therefore it is possible to achieve the same realism as that obtained in forward-direction reproduction.

(Third Embodiment)

In the third embodiment, description will be made with regard to an example which makes it possible to further reduce discontinuity of special reproduced sound occurring at boundaries between minute frames for reverse-direction reproduction.

The configuration of an audio reproducing apparatus according to the third embodiment is the same as that of the second embodiment shown in FIG. 3. The audio reproducing apparatus according to the third embodiment is different from that of the second embodiment in terms of reproducing positions specified by a reproducing speed control unit 2 by means of a reproducing position signal 10.

Specifically, in the third embodiment, the reproducing speed control unit 2 corrects reproducing positions in such a manner that a central source audio position 8 to be reproduced in each minute frame is read at a central time in the minute frame (reproducing speed control step). More specifically, in an arbitrary minute frame [Tₙ˜Tₙ₊₁]=[Tₙ˜Tₙ+T] (n is an arbitrary integer), a reproducing position determined by the following equation (9) or (10) is supplied by the reproducing speed control unit 2 to a counter 18 in the form of a reproducing position signal 10.

In forward-direction reproduction or pause reproduction

0.5{p(Tₙ)+p(Tₙ+T)−T} (9)

In reverse-direction reproduction

0.5{p(Tₙ)+p(Tₙ+T)+T} (10)

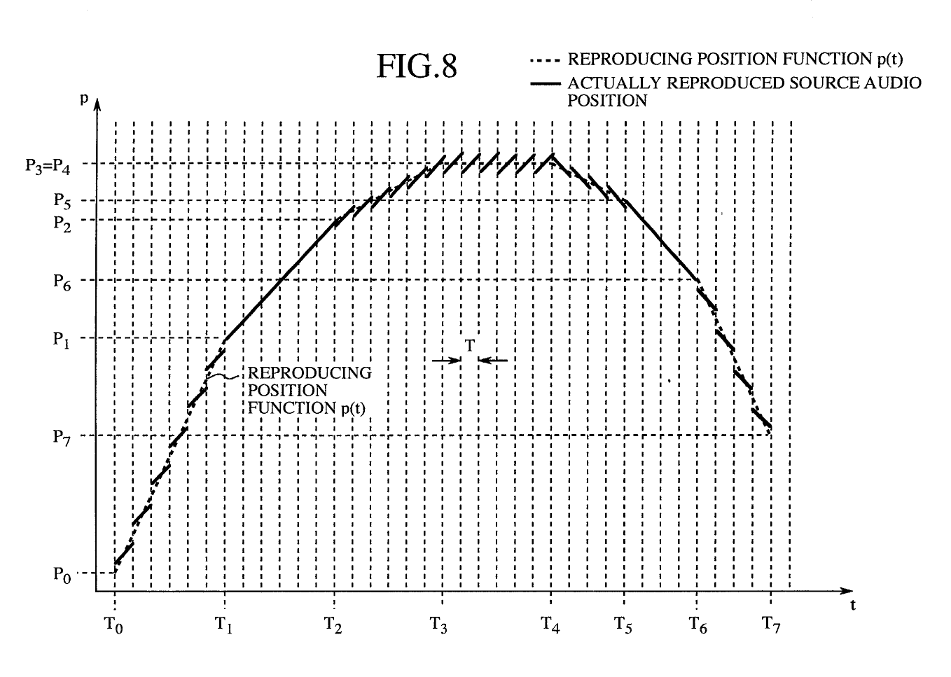

FIG. 8 is a diagram of assistance in explaining an audio reproducing method according to the third embodiment of the present invention. The reproducing position functions of the third embodiment are the same as shown in FIGS. 2 and 7. Audio reproducing methods in a normal reproducing frame [T₁˜T₂] and a reverse-direction single-speed reproducing frame [T₅˜T₆] are the same as those of the first embodiment or the second embodiment. Reproducing frames in which audio reproducing methods are different from those of the second embodiment will be described next.

Forward-direction double-speed reproducing frame [T₀˜T₁]

In a first minute frame [T₀˜T₀+T], p(T₀)=P₀ and p(T₀+T)=P₀+2T are obtained by the reproducing position function (1). Hence, decoded audio data 7 is reproduced in a normal manner by an amount corresponding to time T from a source audio position 8 corresponding to a reproducing position P₀+0.5T obtained by the equation (9). Thus, <P₀+0.5T˜P₀+1.5T> is subjected to reproduction processing.

In the next minute frame [T₀+T˜T₀+2T], p(T₀+T)=P₀+2T and p(T₀+2T)=P₀+4T are obtained by the reproducing position function (1). Hence, decoded audio data 7 is reproduced in a normal manner by an amount corresponding to time T from a source audio position 8 corresponding to a reproducing position P₀+2.5T obtained by the equation (9). Thus, <P₀+1.5T˜P₀+2.5T> is excluded from reproduction processing, while <P₀+2.5T˜P₀+3.5T> is subjected to reproduction processing.

Furthermore, in the next minute frame [T₀+2T˜T₀+3T], p(T₀+2T)=P₀+4T and p(T₀+3T)=P₀+6T are obtained by the reproducing position function (1). Hence, decoded audio data 7 is reproduced in a normal manner by an amount corresponding to time T from a source audio position 8 corresponding to a reproducing position P₀+4.5T obtained by the equation (9). Thus, <P₀3.5T˜P₀+4.5T> is excluded from reproduction processing, while <P₀+4.5T˜P₀+5.5T> is subjected to reproduction processing.

Such reproduction processing is repeated for each minute frame. When <P₀+10.5T˜P₀+11.5T> has been subjected to reproduction processing in the last minute frame [T₀+5T˜T₀+6T], a forward-direction double-speed reproducing frame [T₀˜T₁) is completed.

Forward-direction half-speed reproducing frame [T₂˜T₃]

In a first minute frame [T₂˜T₂+T], p(T₂)=P₂ and p(T₂+T)=P₂+0.5T are obtained by the reproducing position function (3). Hence, decoded audio data 7 is reproduced in a normal manner by an amount corresponding to time T from a source audio position 8 corresponding to a reproducing position P₂−0.25T obtained by the equation (9). Thus, <P₂−0.25T˜P₂+0.75T> is subjected to reproduction processing.

In the next minute frame [T₂+T˜T₂+2T], p(T₂+T)=P₂+0.5T and p(T₂+2T)=P₂+T are obtained by the reproducing position function (3). Hence, decoded audio data 7 is reproduced in a normal manner by an amount corresponding to time T from a source audio position 8 corresponding to a reproducing position P₂+0.25T obtained by the equation (9). Thus, <P₂+0.25T˜P₂+0.75T> is subjected to repeated reproduction processing, while <P₂+0.25T˜P₂+1.25T> is subjected to reproduction processing.

Furthermore, in the next minute frame [T₂+2T˜T₂+3T], p(T₂+2T)=P₂+T and p(T₂+3T)=P₂+1.5T are obtained by the reproducing position function (3). Hence, decoded audio data 7 is reproduced in a normal manner by an amount corresponding to time T from a source audio position 8 corresponding to a reproducing position P₂+0.75T obtained by the equation (9). Thus, <P₂+0.75T˜P₂+1.25T> is subjected to repeated reproduction processing, while <P₂+0.75T˜P₂+1.75T> is subjected to reproduction processing.

Such reproduction processing is repeated for each minute frame. When <P₂+2.25T˜P₂+3.25T> has been subjected to reproduction processing in the last minute frame [T₂+5T˜T₂+6T], a forward-direction half-speed reproducing frame [T₂˜T₃] is completed.

Pause frame [T₃˜T₄]

In a first minute frame [T₃˜T₃+T], p(T₃)=P₃ and p(T₃+T)=P₃ are obtained by the reproducing position function (4). Hence, decoded audio data 7 is reproduced in a normal manner by an amount corresponding to time T from a source audio position 8 corresponding to a reproducing position P₃−0.5T obtained by the equation (9). Thus, <P₃−0.5T˜P₃+0.5T> is subjected to reproduction processing.

Since the frame [T₃˜T₄] is a pause frame, <P₃−0.5T˜P₃+0.5T> is subjected to reproduction processing in each of the following minute frames.

Reverse-direction half-speed reproducing frame [T₄˜T₅]

In a first minute frame [T₄˜T₄+T]. p(T₄)=P₄ and p(T₄+T)=P₄−0.5T are obtained by the reproducing position function (5). Hence, decoded audio data 7 is reproduced in a reverse direction at a single-speed by an amount corresponding to time T from a source audio position 8 corresponding to a reproducing position P₄+0.25T obtained by the equation (10). Thus, <P₄+0.25T˜P₄−0.75T> is subjected to reproduction processing.

In the next minute frame [T₄+T˜T₄+2T], p(T₄+T)=P₄−0.5T and p(T₄+2T)=P₄−T are obtained by the reproducing position function (5). Hence, decoded audio data 7 is reproduced in a reverse direction at a single-speed by an amount corresponding to time T from a source audio position 8 corresponding to a reproducing position P₄−0.25T obtained by the equation (10). Thus, <P_{4+-0.25}T˜P₄−0.75T> is subjected to repeated reproduction processing, while <P₄−0.25T˜P₄−1.25T> is subjected to reproduction processing.

Furthermore, in the next minute frame [T₄+2T˜T₄+3T], p(T₄+2T)=P₄−T and p(T₄+3T)=P₄−1.5T are obtained by the reproducing position function (5). Hence, decoded audio data 7 is reproduced in a reverse direction at a single-speed by an amount corresponding to time T from a source audio position 8 corresponding to a reproducing position P₄−0.75T obtained by the equation (10). Thus, <P₄−0.75T˜P₄−1.25T> is subjected to repeated reproduction processing, while <P₄−0.75T˜P₄−1.75T> is subjected to reproduction processing.

Such reproduction processing is repeated for each minute frame. When <P₄−1.25T˜P₄−2.25T> has been subjected to reproduction processing in the last minute frame [T₄+3T˜T₄+4T], a reverse-direction half-speed reproducing frame [T₄˜T₅] is completed.

Reverse-direction double-speed reproducing frame (T₆˜T₇]

In a first minute frame [T₆˜T₆+T], p(T₆)=P₆ and p (T₆+T)=P₆−2T are obtained by the reproducing position function (7). Hence, decoded audio data 7 is reproduced in a reverse direction at a single-speed by an amount corresponding to time T from a source audio position 8 corresponding to a reproducing position P₆−0.5T obtained by the equation (10). Thus, <P₆−0.5T˜P₆−1.5T> is subjected to reproduction processing.

In the next minute frame [T₆+T˜T₆+2T], p(T₆+T)=P₆−2T and p(T₆+2T)=P₆−4T are obtained by the reproducing position function (7). Hence, decoded audio data 7 is reproduced in a reverse direction at a single-speed by an amount corresponding to time T from a source audio position 8 corresponding to a reproducing position P₆−2.5T obtained by the equation (10). Thus, <P₆−1.5T˜P₆−2.5T> is excluded from reproduction processing, while <P₆−2.5T˜P₆−3.5T> is subjected to reproduction processing.

Furthermore, in the next minute frame [T₆+2T˜T₆+3T], p(T₆+2T)=P₆−4T and p(T₆+3T)=P₆−6T are obtained by the reproducing position function (7). Hence, decoded audio data 7 is reproduced in a reverse direction at a single-speed by an amount corresponding to time T from a source audio position 8 corresponding to a reproducing position P₆−4.5T obtained by the equation (10). Thus, <P₆−3.5T˜P₆−4.5T> is excluded from reproduction processing, while <P₆−4.5T˜P₆−5.5T> is subjected to reproduction processing.

Such reproduction processing is repeated for each minute frame. When <P₆−6.5T˜P₆−7.5T> has been subjected to reproduction processing in the last minute frame [T₆+3T˜T₆+4T], a reverse-direction double-speed reproducing frame [T₆˜T₇] is completed.

A comparison of FIG. 8 with FIG. 7 indicates that the discontinuity of actually reproduced source audio positions 8 is further reduced in FIG. 8. This makes it possible to further suppress effects of high-frequency noise caused by the discontinuity.

When the reproducing speed is continuously varied, reproducing position functions obtained by time integration of reproducing speeds are also continuously changed. Even in such cases, the concept of the third embodiment is applied so that reproducing speed may be continuously varied.

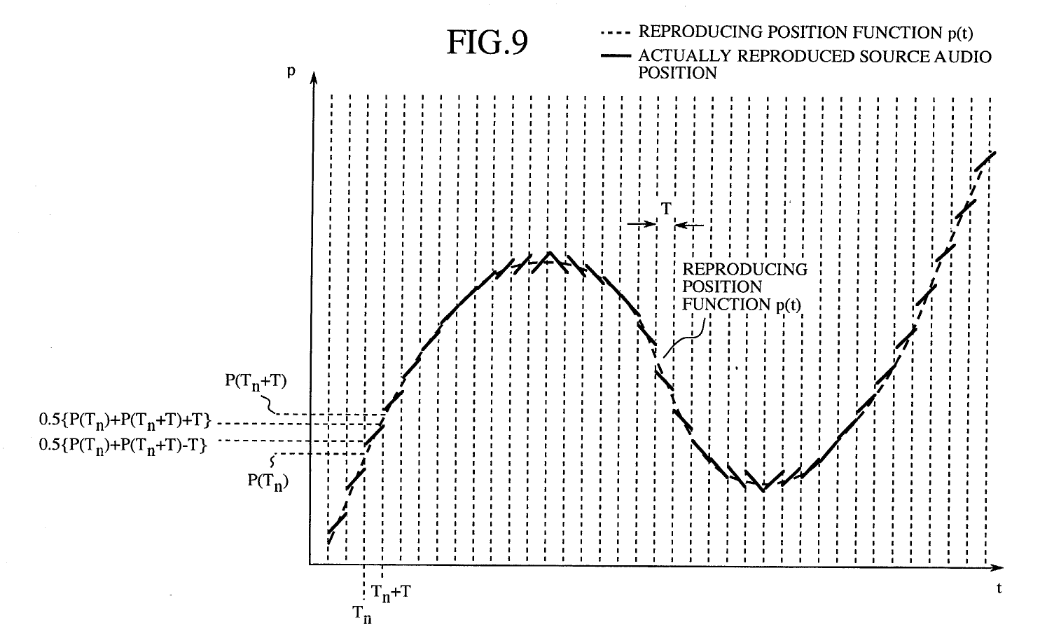

FIG. 9 is a diagram of assistance in explaining an audio reproducing method according to the third embodiment of the present invention, in which reproducing speed is continuously varied.

In FIG. 9, the reproducing position function p(t) is continuously changed. From a microscopic point of view of a minute frame, p(Tₙ) and p(Tₙ+T) are determined from a reproducing position function in an arbitrary minute frame [Tₙ˜Tₙ+T]. Then, according to the equation (9) or (10), <0.5{p(Tₙ)+p(Tₙ+T)−T}˜0.5{p(Tₙ)+p(Tₙ+T)+T}> is reproduced in a normal manner (when reverse-direction reproduction is performed, <0.5{p(Tₙ)+p(Tₙ+T)+T}˜0.5{p(Tₙ)+p(Tₙ+T)−T}> is reproduced in a reverse direction at a single-speed).

As described above, according to the third embodiment, by using the equation (9) in the case of forward-direction and pause reproductions and by using the equation (10) in the case of reverse-direction reproduction, reproducing positions are corrected in such a manner that a central source audio position 8 to be reproduced in each minute frame is read at a central time in the minute frame. Therefore, as compared with the second embodiment, the third embodiment makes it possible to further reduce discontinuity occurring at boundaries between minute frames, and thereby reduce an average gap between actually reproduced data and reproducing position functions. Thus, it is possible to provide special reproduced sound of higher quality and also it is possible to deal with continuous changes in reproducing speed.

(Fourth Embodiment)

In the fourth embodiment, description will be made with regard to an invention that makes it easier to understand the content of special reproduced sound.

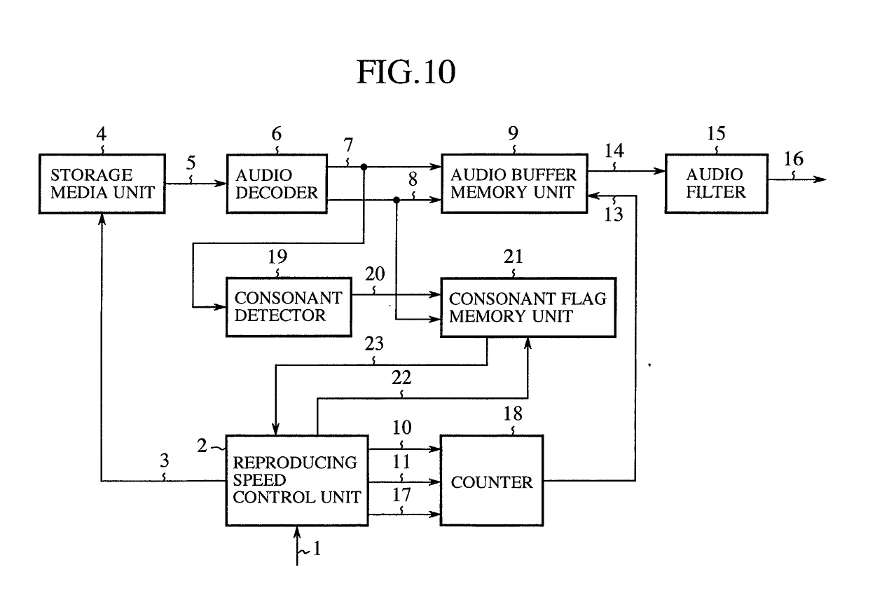

FIG. 10 is a schematic diagram of an audio reproducing apparatus according to the fourth embodiment of the present invention. Configuration parts identical with or corresponding to those in FIG. 6 are identified by the same reference numerals.

In FIG. 10, reference numeral 19 denotes a consonant detector that detects consonant portions from decoded audio data 7. Reference numeral 20 denotes a consonant flag that indicates a consonant portion detected by the consonant detector 19. Reference numeral 21 denotes a consonant flag memory unit (consonant detector) that stores the consonant flag 20 and a source audio position 8 corresponding to the consonant flag 20. Reference numeral 22 denotes a reproducing position that can be obtained according to the first to third embodiments. Reference numeral 23 denotes consonant data that specifies a consonant flag 20 whose source audio position is situated near the reproducing position 22, as well as the source audio position of the consonant flag 20. Configuration parts identical with or corresponding to those in FIG. 6 are identified by the same reference numerals.

Next, the operation of the audio reproducing apparatus according to the fourth embodiment of the present invention will be described.

The consonant detector 19 distinguishes between consonant portions, vowel portions, and silence portions of decoded audio data 7 to detect consonant portions. Then the consonant detector 19 writes consonant flags 20 indicating the consonant portions into the consonant flag memory unit 21. In this case, source audio positions 8 corresponding to the consonant portions of the consonant flags 20 are also written into the consonant flag memory unit 21 (consonant detecting step). The consonant detection by the consonant detector 19 is performed by a known technique, and therefore its description will be omitted.

After the reproducing speed control unit 2 supplies the consonant flag memory unit 21 with a reproducing position 22 determined for each minute frame, the consonant flag memory unit 21 retrieves a consonant flag 20 whose source audio position is judged to be near the reproducing position 22, and thereby outputs consonant data 23 to the reproducing speed control unit 2. After receiving the consonant data 23, the reproducing speed control unit 2 corrects source audio positions to be reproduced in each minute frame in such a manner that a consonant portion is included in each minute frame so as to be reproduced. Then, the reproducing speed control unit 2 supplies a reproducing position signal 10 to a counter 18 (reproducing speed control step).

When the counter 18 reads decoded audio data 7 in a normal manner from an audio buffer memory unit 9 according to the reproducing position signal 10, reproduced audio data 14 that has been read includes the consonant portion detected by the consonant detector 19. Thus, it becomes easier to understand the content of reproduced sound 16.

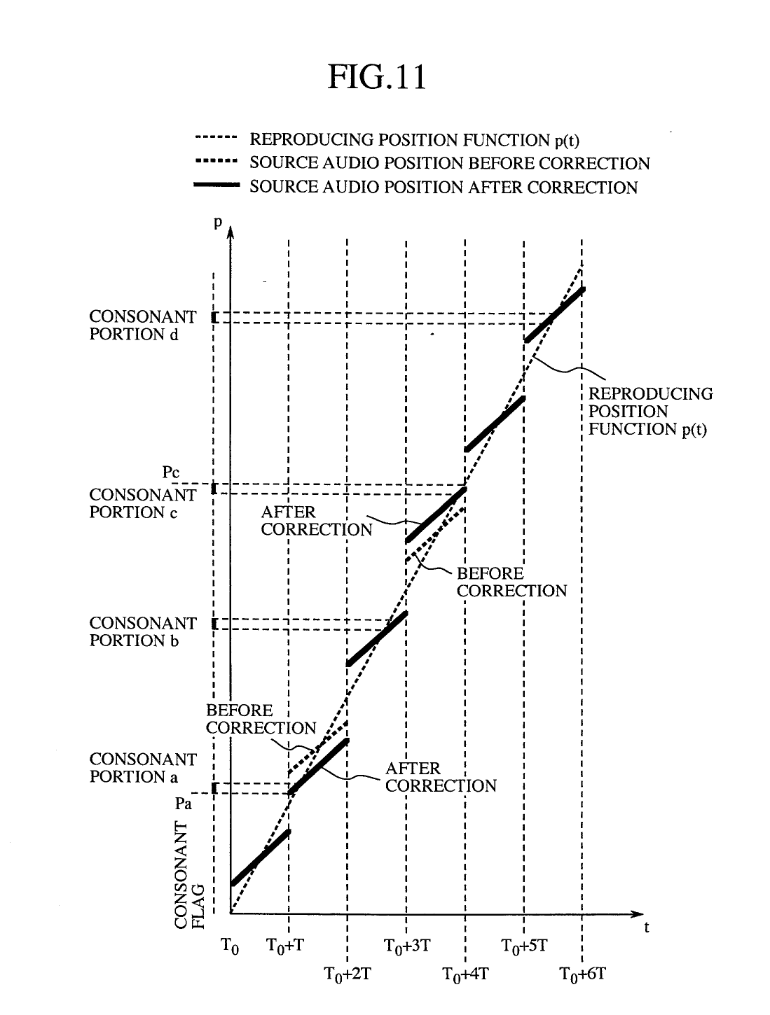

FIG. 11 is a diagram of assistance in explaining an audio reproducing method according to the fourth embodiment of the present invention. Source audio positions subjected to reproduction processing in six minute frames [T₀+T], . . . , [T₀+6T] are expressed as equations (11) to (16) respectively according to the third embodiment, for example.

<0.5{p(T₀)+p(T₀+T)−T}˜0.5{p(T₀)+p(T₀+T)+T}> (11)

<0.5{p(T₀+T)+p(T₀+2T)−T}˜0.5{p(T₀+T)+p(T₀+2T)+T}> <0.5{p(T₀+2T)+p(T₀+3T)−T} (12)

˜0.5{p(T₀+2T)+p(T₀+3T)+T}> <0.5{p(T₀+3T)+p(T₀+4T)−T}˜0.5{(T₀+3T)+p(T₀+4T)+T}> (14)

<0.5{p(T₀+4T)+p(T₀+5T)−T}˜0.5{p(T₀+4T)+p(T₀+5T)+T}> <0.5{p(T₀+5T)+p(T₀+6T)−T}˜0.5{p(T₀+5T)+p(T₀+6T)+T}> (16)

In the following, a case where-consonant portions a to d are detected by the consonant detector 19, as shown in FIG. 11, is considered. Source audio positions before correction in FIG. 11 do not include source audio positions of consonant portions a and c. Therefore, when reproduction processing is performed at the source audio positions before correction, all of or part of the consonant portions a and c are not reproduced, thereby making it difficult to understand the content of the special reproduced sound.

Thus, in the fourth embodiment, the reproducing speed control unit 2 corrects source audio positions to be reproduced in a minute frame [T₀+T˜T₀+2T] and a minute frame [T₀+3T˜T₀+4T] according to equations (17) and (18), respectively. In the equations, Pₐ is a source audio position where the consonant a begins, while P_{c} is a source audio position where the consonant c ends.

[T₀+T˜T₀+2T]:<Pₐ˜Pₐ+T> (17)

[T₀+3T˜T₀+4T]:<P_{c}−T˜P_{c}> (18)

When the counter 18 reads decoded audio data 7 in a normal manner from the audio buffer memory unit 9 according to the source audio positions corrected by the equations (17) and (18), the minute frames [T₀+T˜T₀+2T] and [T₀+3T˜T₀+4T] of reproduced audio data 14 include the consonants a and c, respectively. Thus, it becomes easier to understand the content of reproduced sound 16 resulting from special reproduction processing.

Corrections by the equations (17) and (18) in the minute frame [T₀+T˜T₀+2T] and the minute frame [T₀+3T˜T₀+4T] are performed with respect to the source audio position Pₐ where the consonant a begins and with respect to the source audio position P_{c} where the consonant c ends, respectively. Such corrections are determined from relative positional relations between source audio positions before correction and the source audio positions of consonant portions in such a way as to minimize the amount of correction of source audio positions.

As described above, according to the fourth embodiment, there are provided a consonant detector 19 for detecting a consonant portion from decoded audio data 7; and a consonant flag memory unit 21 for storing a consonant flag 20 indicating the consonant portion and a source audio position 8 corresponding to the consonant flag 20; wherein a consonant portion whose source audio position is near a reproducing position in a minute frame is retrieved by referring to consonant flags 20 and source audio positions 8 stored in the consonant flag memory unit 21, and a reproducing speed control unit 2 corrects source audio positions in such a manner that the consonant portion is included in the minute frame so as to be reproduced. Therefore, the frequency of consonant output in special reproduced sound is increased, thereby making it easier to understand the content of special reproduced sound.

(Fifth Embodiment)

In the fifth embodiment, description will be made with regard to a video-audio reproducing apparatus that includes an audio reproducing apparatus according to the first to fourth embodiments, and performs special video reproduction while ensuring matching between sound and images.

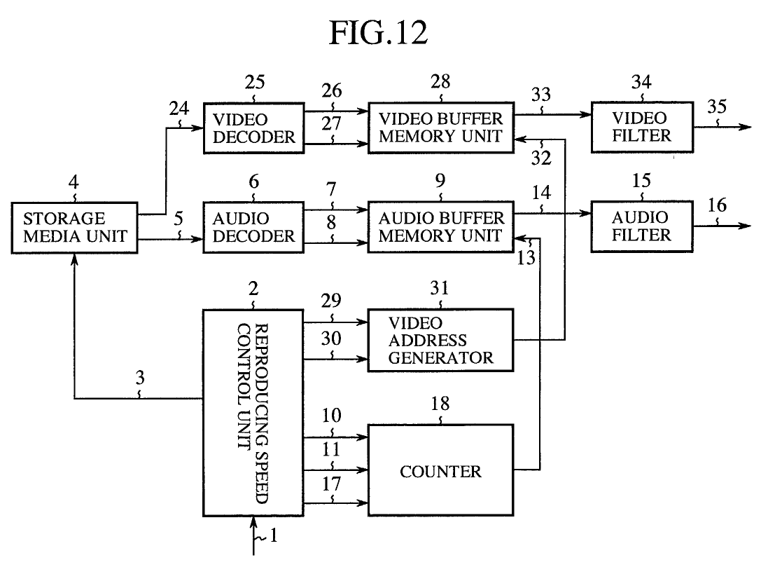

FIG. 12 is a schematic diagram of a video-audio reproducing apparatus according to the fifth embodiment of the present invention. Configuration parts identical with or corresponding to those in FIG. 10 are identified by the same reference numerals. A storage media unit 4 stores source video data such as moving images in addition to source audio data 5.

In FIG. 12, reference numeral 24 denotes source video data read from the storage media unit 4 according to a reading position signal 3. Reference numeral 25 denotes a video decoder that decodes the source video data 24. Reference numeral 26 denotes decoded video data decoded by the video decoder 25.

Reference numeral 27 denotes a source video position outputted in correspondence with the decoded video data 26. Reference numeral 28 denotes a video buffer memory unit that temporarily stores the decoded video data 26 and the source video position 27. Reference numeral 29 denotes a reproducing address signal that specifies a reproducing address that is calculated by a reproducing position function. In this case, the source video position 27 means reproducing time that has elapsed when all of the video data recorded in the storage media unit 4 is reproduced from the beginning in a normal manner.

Reference numeral 30 denotes a minute frame periodic pulse having a period Tᵥ for generating video minute frames (minute frames for an image). Reference numeral 31 denotes a video address generator that receives the reproducing address signal 29 and also counts the minute frame periodic pulse 30. Reference numeral 32 denotes a source video position specifying signal that specifies a source video position 27 to be reproduced by determining the position from the reproducing address signal 29 and a count value of the minute frame periodic pulse 30. Reference numeral 33 denotes reproduced video data that is reproduced from the video buffer memory unit 28. Reference numeral 34 denotes a video filter that filters the reproduced video data 33. Reference numeral 35 denotes a reproduced image outputted by the video-audio reproducing apparatus of the fifth embodiment.

Next, the operation of the video-audio reproducing apparatus according to a fifth embodiment of the present invention will be described.

The operation of the video-audio reproducing apparatus for special audio reproduction is performed in the same manner as described in the first to fourth embodiments.

Normal video reproduction is performed as follows. Source video data 24 is decoded by the video decoder 25, and the video buffer memory unit 28 and the video filter 34 are brought into a through state (a passage state) (through state of a video data buffering step and a video data filtering step), whereby a reproduced image 35 in normal reproduction is obtained.

When the reproducing speed control unit 2 externally receives a reproducing command 1 for special reproduction that specifies a reproducing speed such as fast forward or slow motion (a positive value in the case of forward-direction reproduction and a negative value in the case of reverse-direction reproduction), the reproducing command including a reproducing direction, which is either a forward direction or a reverse direction, the reproducing speed control unit 2 outputs a reading position signal 3 to the storage media unit 4. The storage media unit 4 outputs source video data 24, which is read from a reading position specified by the reading position signal 3, to the video decoder 25.

The video decoder 25 outputs decoded video data 26 obtained by decoding the source video data 24 to the video buffer memory unit 28, and also writes a source video position 27 corresponding to the decoded video data 26 into the video buffer memory unit 28 (video data buffering step).

Processing for special reproduction is performed after a certain amount of the decoded video data 26 is stored in the video buffer memory unit 28. Specifically, the reading of the decoded video data 26 from the video buffer memory unit 28 will be performed after an amount of the decoded video data 26 that is necessary and sufficient for special reproduction processing is written into the video buffer memory unit 28.

The reproducing speed control unit 2 outputs a minute frame periodic pulse 30 having a period Tᵥ to the video address generator 31, and at the same time, reproducing positions calculated by reproducing position functions according to the first to fourth embodiments are also applied to video reproduction. Specifically, the reproducing speed control unit 2 outputs a reproducing address signal 29 that specifies a reproducing address obtained on the basis of a reproducing position to the video address generator 31 (reproducing speed control step).

After receiving the reproducing address signal 29, the video address generator 31 specifies, as a vertical-horizontal pixcel position, a source video position 27 corresponding to a reproducing address of the reproducing address signal 29, and supplies the source video position 27 to the video buffer memory unit 28 by means of a source video position specifying signal 32. The decoded video data 26 in the video buffer memory unit 28 is read, as in audio reproduction, from the source video position 27 as reproduced video data 33 by an amount corresponding to the period T, of the minute frame periodic pulse 30 (video data reading step).

As in the case of audio reproduction, discontinuity of the reproduced video data 33 occurs at a boundary between minute frames. Thus, in order to remove noise on the time axis, the reproduced video data 33 is filtered by the video filter 34, and thereby a reproduced image 35 is obtained (video data filtering step).

In the operation described above, the reading by the video address generator 31 of decoded video data 26 stored in the video buffer memory unit 28 will be described in further detail.

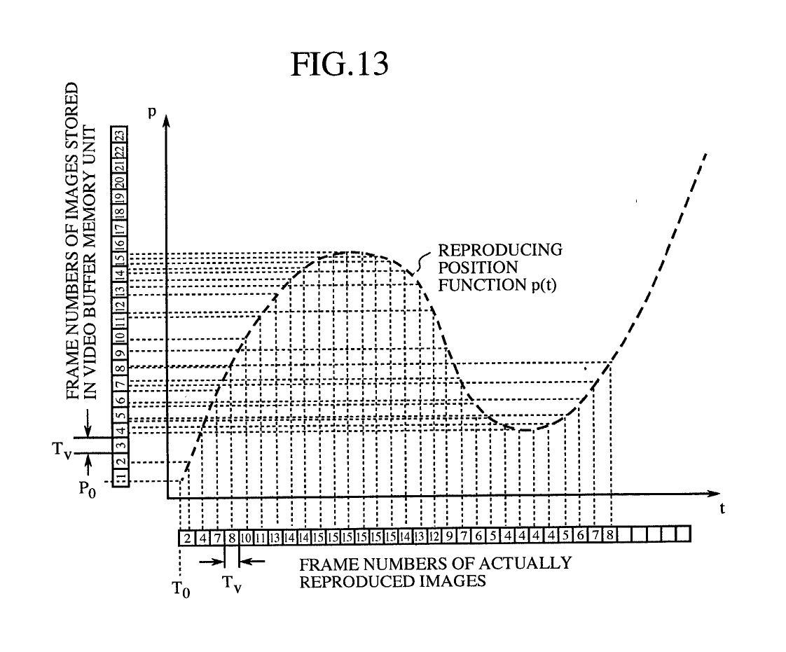

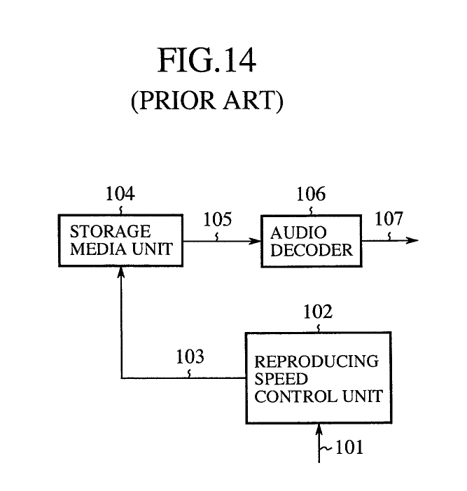

FIG. 13 is a diagram of assistance in explaining a video-audio reproducing method according to the fifth embodiment of the present invention.

A reproducing position function p(t) in FIG. 13 is the same as a reproducing position function for audio reproduction, and in this case, the reproducing position function p(t) is the same as that of FIG. 9. At a time T₀, a reproducing position p(T₀)=P₀, and P₀ is set to correspond to an intermediate point in an image frame 1.

In a minute frame [T₀˜T₀+Tᵥ], an image frame 2 at a reproducing address corresponding to a reproducing position p(T₀+0.5Tᵥ) at a central time T₀+0.5Tᵥ of the minute frame is displayed.

In the next minute frame [T₀+Tᵥ˜T₀+2Tᵥ], an image frame 4 at a reproducing address corresponding to a reproducing position p(T₀+1.5Tᵥ) at a central time T₀+1.5Tᵥ of the minute frame is displayed.

Furthermore, in the next minute frame [T₀+2Tᵥ˜T₀+3Tᵥ], an image frame 7 at a reproducing address corresponding to a reproducing position p(T₀+2.5Tᵥ) at a central time T₀+2.5Tᵥ of the minute frame is displayed.

Similarly, image frames 8, 10, 11, 13, 14, . . . are displayed in that order.

In the fifth embodiment, an image frame corresponding to a reproducing position at a central time of each minute frame is displayed. However, an image frame corresponding to a reproducing position obtained by averaging a reproducing position at a start time of a minute frame and a reproducing position at its end time may be displayed. In this case, an image frame to be reproduced in a minute frame [T₀˜T₀+Tᵥ], for example, is one at a reproducing address corresponding to a reproducing position 0.5{p(T₀)+p(T₀+Tᵥ)}.

As described above, according to the fifth embodiment, there are provided a video buffer memory unit 28 for temporarily storing decoded video data 26 obtained by decoding source video data 24 and a source video position 27 representing reproducing time that has elapsed when all the source video data 24 is reproduced from the beginning in a normal manner, the decoded video data 26 and the source video position 27 being made to correspond to each other; a reproducing speed control unit 2 for generating a minute frame periodic pulse 30 having a period Tᵥ and a reproducing address signal 29 that specifies a reproducing address corresponding to a reproducing position at a central time of a minute frame, the reproducing position being calculated from a reproducing position function used for audio reproduction processing; and a video address generator 31 for receiving the reproducing address signal 29 and the minute frame periodic pulse 30 and outputting reproduced video data 33 obtained by reproducing the decoded video data 26 in the video buffer memory unit 28 in a normal manner from a source video position 27 corresponding to the reproducing address by an amount corresponding to a period Tᵥ of the minute frame periodic pulse 30. Therefore, it is possible to perform special reproduction while ensuring matching between moving images and sound.

In addition, according to the fifth embodiment, a video filter 34 for filtering the reproduced video data 33 is provided. Therefore, it is possible to eliminate noise on a time axis caused by discontinuity of the reproduced video data 33, and thereby output a special reproduced image of higher quality.

Furthermore, according to the fifth embodiment, the video buffer memory unit 28 and the video filter 34 are each brought into a through state and the decoded video data 26 is read, so that a reproduced image 35 in normal reproduction can be outputted.

As described above, according to the present invention, decoded audio data is divided by a minute frame, and a reproducing position for each minute frame is determined by a reproducing position function obtained by time integration of a reproducing speed, so that the decoded audio data is reproduced in a normal manner from source audio positions each corresponding to a reproducing position by an amount corresponding to the minute frame. Therefore, a minute frame that has been subjected to reproduction processing retains a source audio frequency. Also, depending on the reproducing speed, each minute frame is excluded from reproduction processing or is subjected to repeated reproduction processing. Thus, it is possible to perform special reproduction without producing sound that is difficult to hear.

According to the present invention, there are provided an audio buffer memory unit for temporarily storing decoded audio data and a source audio position in correspondence with each other; a reproducing speed control unit for outputting reproducing positions calculated individually for each minute frame by a reproducing position function that is obtained by time integration of a reproducing speed; and a counter for reproducing the decoded audio data in the audio buffer memory unit in a normal manner from source audio positions respectively corresponding to the reproducing positions by an amount corresponding to a minute frame. Therefore, a minute frame that has been subjected to reproduction processing retains a source audio frequency. Also, depending on the reproducing speed, each minute frame is excluded from reproduction processing or is subjected to repeated reproduction processing. Thus, it is possible to perform special reproduction without producing sound that is difficult to hear.

According to the present invention, an audio filter for filtering the decoded audio data reproduced by the counter in a normal manner is provided. Therefore, it is possible to eliminate high-frequency noise caused by discontinuity of the decoded audio data reproduced in a normal manner, and thereby output special reproduced sound of higher quality.

According to the present invention, the audio buffer memory unit is brought into a through state and the decoded audio data is outputted, so that normal reproduced sound can be outputted.

According to the present invention, the audio buffer memory unit and the audio filter are each brought into a through state and the decoded audio data is outputted, so that normal reproduced sound can be outputted.

According to the present invention, when reverse-direction reproduction is performed, the counter reproduces decoded audio data in the audio buffer memory unit in a reverse direction at a single-speed from source audio positions each corresponding to a reproducing position by an amount corresponding to a minute frame. Therefore, it is possible to reduce discontinuity occurring at boundaries between minute frames for reverse-direction reproduction, and thereby it is possible to output special reproduced sound of high quality while suppressing high-frequency noise. Also, when reverse-direction reproduction is performed, decoded audio data is read in a reverse direction, and therefore it is possible to achieve the same realism as that obtained in forward-direction reproduction.

According to the present invention, the reproducing speed control unit corrects a reproducing position for output in such a manner that a central source audio position of decoded audio data to be reproduced by an amount corresponding to a minute frame in a normal manner or in a reverse direction at a single-speed is read at a central time of each minute frame. Therefore, it is possible to further reduce discontinuity occurring at boundaries between minute frames, and thereby reduce an average gap between actually reproduced data and reproducing position functions. Thus, it is possible to provide special reproduced sound of higher quality and also it is possible to deal with continuous changes in reproducing speed.

According to the present invention, a consonant detector for detecting a consonant portion and a source audio position of the consonant portion from decoded audio data is provided, whereby referring to the consonant detector, the reproducing speed control unit corrects a reproducing position for output in such a manner that the source audio position of the consonant portion is included in source audio positions of decoded audio data to be reproduced by an amount corresponding to a minute frame in a normal manner or in a reverse direction at a single-speed. Therefore, the frequency of consonant output in special reproduced sound is increased, thereby making it easier to understand the content of special reproduced sound.

According to the present invention, there are provided an audio data buffering step for temporarily storing decoded audio data and a source audio position in correspondence with each other; a reproducing speed control step for outputting reproducing positions calculated individually for each minute frame by a reproducing position function that is obtained by time integration of a reproducing speed; and an audio data reading step for reproducing the decoded audio data in the audio data buffering step in a normal manner from source audio positions respectively corresponding to the reproducing positions by an amount corresponding to a minute frame. Therefore, a minute frame that has been subjected to reproduction processing retains a source audio frequency. Also, depending on the reproducing speed, each minute frame is excluded from reproduction processing or is subjected to repeated reproduction processing. Thus, it is possible to perform special reproduction without producing sound that is difficult to hear.

According to the present invention, an audio data filtering step for filtering the decoded audio data reproduced in a normal manner in the audio data reading step is provided. Therefore, it is possible to eliminate high-frequency noise caused by discontinuity of the decoded audio data reproduced in a normal manner, and thereby output special reproduced sound of higher quality.

According to the present invention, the audio data buffering step is brought into a through state and the decoded audio data is outputted, so that normal reproduced sound can be outputted.

According to the present invention, the audio data buffering step and the audio data filtering step are each brought into a through state and the decoded audio data is outputted, so that normal reproduced sound can be outputted.

According to the present invention, when reverse-direction reproduction is performed, decoded audio data in the audio data buffering step is reproduced in the audio data reading step in a reverse direction at a single-speed from source audio positions each corresponding to a reproducing position by an amount corresponding to a minute frame. Therefore, it is possible to reduce discontinuity occurring at boundaries between minute frames for reverse-direction reproduction, and thereby it is possible to output special reproduced sound of high quality while suppressing high-frequency noise. Also, when reverse-direction reproduction is performed; decoded audio data is read in a reverse direction, and therefore it is possible to achieve the same realism as that obtained in forward-direction reproduction.

According to the present invention, a reproducing position is corrected for output in the reproducing speed control step in such a manner that a central source audio position of decoded audio data to be reproduced by an amount corresponding to a minute frame in a normal manner or in a reverse direction at a single-speed is read at a central time of each minute frame. Therefore, it is possible to further reduce discontinuity occurring at boundaries between minute frames, and thereby reduce an average gap between actually reproduced data and reproducing position functions. Thus, it is possible to provide special reproduced sound of higher quality and also it is possible to deal with continuous changes in reproducing speed.

According to the present invention, a consonant detecting step for detecting a consonant portion and a source audio position of the consonant portion from decoded audio data is provided, whereby referring to the consonant detecting step, a reproducing position is corrected for output in the reproducing speed control step in such a manner that the source audio position of the consonant portion is included in source audio positions of decoded audio data to be reproduced by an amount corresponding to a minute frame in a normal manner or in a reverse direction at a single-speed. Therefore, the frequency of consonant output in special reproduced sound is increased, thereby making it easier to understand the content of special reproduced sound.

According to the present invention, there are provided a video-audio reproducing apparatus for performing special reproductions of decoded audio data and decoded video data according to reproducing speed, comprising: an audio buffer memory unit for temporarily storing the decoded audio data and a source audio position in correspondence with each other; a reproducing speed control unit for outputting reproducing positions calculated individually for each minute frame by a reproducing position function that is obtained by time integration of the reproducing speed; and a counter for reproducing the decoded audio data in the audio buffer memory unit in a normal manner from the source audio positions respectively corresponding to the reproducing positions by an amount corresponding to the minute frame, wherein the reproducing speed control unit further outputs a reproducing address for each minute frame for an image, which reproducing addresses each corresponding to a reproducing position calculated by the reproducing position function, and wherein the video-audio reproducing apparatus further comprises; a video buffer memory unit for temporarily storing decoded video data and a source video position in correspondence with each other; and a video address generator for outputting the decoded video data in the video buffer memory unit from the source video positions respectively corresponding to the reproducing addresses by an amount corresponding to the minute frame for an image. Therefore, it is possible to perform special reproduction while ensuring matching between moving images and sound.

According to the present invention, a video filter for filtering the decoded video data outputted by the video address generator is provided. Therefore, it is possible to eliminate noise on a time axis caused by discontinuity of the outputted decoded video data, and thereby it is possible to output a special reproduced image of higher quality.

According to the present invention, the video buffer memory unit is brought into a through state and the decoded video data is outputted, so that a normal reproduced image can be outputted.

According to the present invention, the video buffer memory unit and the video filter are each brought into a through state and the decoded video data is outputted, so that a normal reproduced image can be outputted.

According to the present invention, there are provided a video-audio reproducing method for performing special reproduction of decoded audio data and decoded video data according to reproducing speed, which method comprises; an audio data buffering step for temporarily storing the decoded audio data and a source audio position in correspondence with each other; reproducing speed control step for outputting reproducing positions calculated individually for each minute frame by a reproducing position function that is obtained by time integration of the reproducing speed; and an audio data reading step for reproducing the decoded audio data in the audio data buffering step in a normal manner from the source audio positions respectively corresponding to the reproducing positions by an amount corresponding to the minute frame, wherein in the reproducing speed control step, a reproducing address for each minute frame for an image is further outputted, which reproducing addresses each corresponding to a reproducing position calculated by the reproducing position function, and wherein the video-audio reproducing method further comprises: a video data buffering step for temporarily storing decoded video data and a source video position in correspondence with each other; and a video address generating step for outputting the decoded video data in a video buffer memory unit from the source video positions respectively corresponding to the reproducing addresses by an amount corresponding to the minute frame for an image. Therefore, it is possible to perform special reproduction while ensuring matching between moving images and sound.

According to the present invention, a video filtering step for filtering the decoded video data outputted in the video address generating step is provided. Therefore, it is possible to eliminate noise on a time axis caused by discontinuity of the outputted decoded video data, and thereby it is possible to output a special reproduced image of higher quality.

According to the present invention, the video data buffering step is brought into a through state and the decoded video data is outputted, so that a normal reproduced image can be outputted.

According to the present invention, the video data buffering step and the video filtering step are each brought into a through state and the decoded video data is outputted, so that a normal reproduced image can be outputted. What is claimed is;

1. An audio reproducing apparatus for performing special reproductions of decoded audio data according to reproducing speed, wherein said decoded audio data is divided by a minute frame, and a reproducing position for each of said minute frames is determined by a reproducing position function obtained by time integration of said reproducing speed, so that said decoded audio data is reproduced in a normal manner from source audio positions respectively corresponding to said reproducing positions by an amount corresponding to the minute frame.

2. An audio reproducing apparatus for performing special reproductions of decoded audio data according to reproducing speed, comprising:
an audio buffer memory unit for temporarily storing said decoded audio data and a source audio position in correspondence with each other;
a reproducing speed control unit for outputting reproducing positions calculated individually for each minute frame by a reproducing position function that is obtained by time integration of said reproducing speed; and
a counter for reproducing said decoded audio data in said audio buffer memory unit in a normal manner from said source audio positions respectively corresponding to said reproducing positions by an amount corresponding to said minute frame.

3. The audio reproducing apparatus according to claim 2, further including an audio filter for filtering the decoded audio data reproduced by the counter in a normal manner.

4. The audio reproducing apparatus according to claim 2, wherein the audio buffer memory unit is brought into a through state, whereby the decoded audio data is outputted.

5. The audio reproducing apparatus according to claim 3, wherein the audio buffer memory unit and the audio filter are each brought into a through state, whereby the decoded audio data is outputted.

6. The audio reproducing apparatus according to claim 2, wherein when reverse-direction reproduction is performed, the counter reproduces decoded audio data in the audio buffer memory unit i n a reverse direction at a single-speed from source audio positions each corresponding to a reproducing position by an amount corresponding to a minute frame.

7. The audio reproducing apparatus according to claim 2, wherein the reproducing speed control unit corrects a reproducing position for output in such a manner that a central source audio position of decoded audio data to be reproduced by an amount corresponding to a minute frame in a normal manner or in a reverse direction at a single-speed is read at a central time of each minute frame.

8. The audio reproducing apparatus according to claim 2, further including a consonant detector for detecting a consonant portion and a source audio position of said consonant portion from decoded audio data, whereby referring to said consonant detector, the reproducing speed control unit corrects a reproducing position for output in such a manner that the source audio position of said consonant portion is included in source audio positions of decoded audio data to be reproduced by an amount corresponding to a minute frame in a normal manner or in a reverse direction at a single-speed.

9. An audio reproducing method for performing special reproductions of decoded audio data according to reproducing speed, wherein said decoded audio data is divided by a minute frame, and a reproducing position for each of said minute frames is determined by a reproducing position function obtained by time integration of said reproducing speed, so that said decoded audio data is reproduced in a normal manner from source audio positions respectively corresponding to said reproducing positions by an amount corresponding to the minute frame, said method comprising:
an audio data buffering step for temporarily storing said decoded audio data and a source audio position in correspondence with each other;
a reproducing speed control step for outputting reproducing positions calculated individually for each minute frame by a reproducing position function that is obtained by time integration of said reproducing speed; and
an audio data reading step for reproducing said decoded audio data in said audio data buffering step in a normal manner from said source audio positions respectively corresponding to said reproducing positions by an amount corresponding to said minute frame.

10. The audio reproducing method according to claim 9, further including an audio data filtering step for filtering the decoded audio data reproduced in a normal manner in the audio data reading step.

11. The audio reproducing method according to claim 9, wherein the audio data buffering step is brought into a through state, whereby the decoded audio data is outputted.

12. The audio reproducing method according to claim 10, wherein the audio data buffering step and the audio data filtering step are each brought into a through state, whereby the decoded audio data is outputted.

13. The audio reproducing method according to claim 9, wherein when reverse-direction reproduction is performed, decoded audio data in the audio data buffering step is reproduced in the audio data reading step in a reverse direction at a single-speed from source audio positions each corresponding to a reproducing position by an amount corresponding to a minute frame.

14. The audio reproducing method according to claim 9, wherein a reproducing position is corrected for output in the reproducing speed control step in such a manner that a central source audio position of decoded audio data to be reproduced by an amount corresponding to a minute frame in a normal manner or in a reverse direction at a single-speed is read at a central time of each minute frame.

15. The audio reproducing method according to claim 9, further including a consonant detecting step for detecting a consonant portion and a source audio position of said consonant portion from decoded audio data, whereby referring to said consonant detecting step, a reproducing position is corrected for output in the reproducing speed control step in such a manner that the source audio position of said consonant portion is included in source audio positions of decoded audio data to be reproduced by an amount corresponding to a minute frame in a normal manner or in a reverse direction at a single-speed.

16. A video-audio reproducing apparatus for performing special reproductions of decoded audio data and decoded video data according to reproducing speed, comprising:
an audio buffer memory unit for temporarily storing said decoded audio data and a source audio position in correspondence with each other;
a reproducing speed control unit for outputting reproducing positions calculated individually for each minute frame by a reproducing position function that is obtained by time integration of said reproducing speed; and
a counter for reproducing said decoded audio data in said audio buffer memory unit in a normal manner from said source audio positions respectively corresponding to said reproducing positions by an amount corresponding to said minute frame,
wherein said reproducing speed control unit further outputs a reproducing address for each minute frame for an image, said reproducing addresses each corresponding to a reproducing position calculated by the reproducing position function, and wherein said video-audio reproducing apparatus further comprises;
a video buffer memory unit for temporarily storing decoded video data and a source video position in correspondence with each other; and
a video address generator for outputting said decoded video data in said video buffer memory unit from said source video positions respectively corresponding to said reproducing addresses by an amount corresponding to said minute frame for an image.

17. The video-audio reproducing apparatus according to claim 16, further including a video filter for filtering the decoded video data outputted by the video address generator.

18. The video-audio reproducing apparatus according to claim 16, wherein the video buffer memory unit is brought into a through state, whereby the decoded video data is outputted.

19. The video-audio reproducing apparatus according to claim 17, wherein the video buffer memory unit and the video filter are each brought into a through state, whereby the decoded video data is outputted.

20. A video-audio reproducing method for performing special reproduction of decoded audio data and decoded video data according to reproducing speed, said method comprising:
an audio data buffering step for temporarily storing said decoded audio data and a source audio position in correspondence with each other;
a reproducing speed control step for outputting reproducing positions calculated individually for each minute frame by a reproducing position function that is obtained by time integration of said reproducing speed; and
an audio data reading step for reproducing said decoded audio data in said audio data buffering step in a normal manner from said source audio positions respectively corresponding to said reproducing positions by an amount corresponding to said minute frame,
wherein in said reproducing speed control step, a reproducing address for each minute frame for an image is further outputted, said reproducing addresses each corresponding to a reproducing position calculated by the reproducing position function, and wherein said video-audio reproducing method further comprises:
a video data buffering step for temporarily storing decoded video data and a source video position in correspondence with each other; and
a video address generating step for outputting said decoded video data in a video buffer memory unit from said source video positions respectively corresponding to said reproducing addresses by an amount corresponding to said minute frame for an image.

21. The video-audio reproducing method according to claim 20, further including a video filtering step for filtering the decoded video data outputted in the video address generating step.

22. The video-audio reproducing method according to claim 20, wherein the video data buffering step is brought into a through state, whereby the decoded video data is outputted.

23. The video-audio reproducing method according to claim 21, wherein the video data buffering step and the video filtering step are each brought-into a through state, whereby the decoded video data is outputted.
